(19) United States
(12) Patent Application Publication
(10) Pub. No.: US 2026/0260391 A1
(43) Pub. Date: Sep. 3, 2026

(54) SYSTEMS AND METHODS FOR ITERATIVE NON-AUTOREGRESSIVE IMAGE SYNTHESIS USING INDEPENDENT TOKEN-CRITIC MODEL

(71) Applicant: Google LLC, Mountain View, CA (US)

(72) Inventors: José Lezama, Atlanta, GA (US); Huiwen Chang, New York, NY (US); Lu Jiang, Mountain View, CA (US); Tim Salimans, Utrecht (NL); Jonathan Ho, New York, NY (US); Irfan Essa, Atlanta, GA (US)

(21) Appl. No.: 18/993,795

(22) PCT Filed: Aug. 30, 2022
(86) PCT No.: PCT/US2022/041995

§ 371 Date: Jan. 13, 2025

(51) Int. Cl. G06T 11/00; G06N 3/045; G06N 3/0895

(52) U.S. Cl. CPC G06T 11/00; G06N 3/045; G06N 3/0895

(57) ABSTRACT

Systems and methods for iterative non-autoregressive image synthesis using a first generative model and an independent second token-critic model. In some examples, an image may be synthesized using one or more passes in which the generative model predicts a first plurality of tokens representing a first vector-quantized image, the token-critic model generates a first plurality of scores based on the first plurality of tokens, the processing system selects a first set of one or more tokens of the first plurality of tokens to be preserved based on the first plurality of scores, and the generative model then predicts a second plurality of tokens based on the first set of tokens, the second plurality of tokens including the first set of tokens. In some examples, the generative model may be configured to predict probability distributions, which may be sampled to generate the first and second pluralities of tokens.

### BACKGROUND

Creating an image model capable of efficiently generating varied and semantically meaningful images that appear realistic and lack obvious visual artifacts is an ongoing challenge in the art. Generative adversarial networks (“GANs”) can offer state-of-the-art speed, but with some limitations on the variety and realism of the images they can generate. Likelihood-based models such as autoregressive transformers and continuous diffusion models may provide improved image quality over GANs, but may require hundreds of steps to synthesize an image, thus making them orders of magnitude slower. More recently, developments in non-autoregressive transformers and discrete diffusion models have offered a promising middle ground, enabling image quality comparable to state-of-the-art autoregressive transformers and continuous diffusion models, while doing so up to two orders of magnitude faster than autoregressive transformers and continuous diffusion models.

### BRIEF SUMMARY

The present technology is related to systems and methods for further improving the quality and diversity of images produced by non-autoregressive image models such as non-autoregressive transformers and discrete diffusion models. In that regard, the present technology concerns systems and methods for iterative non-autoregressive image synthesis using a first generative model (e.g., a bidirectional encoder transformer), and an independent second token-critic model (e.g., another bidirectional encoder transformer) trained to predict whether each token was or was not produced by a generative model. For example, in some aspects of the technology, an image may be synthesized in successive passes in which the first “generative” model predicts a first plurality of tokens representing a first vector-quantized image, the second “token-critic” model generates a first plurality of scores based on the first plurality of tokens, the processing system selects a first set of one or more tokens of the first plurality of tokens to be preserved based on the first plurality of scores, and the generative model then predicts a second plurality of tokens based on the first set of tokens. This second plurality of tokens may be an output vector which incorporates the first set of tokens and the generative model's predictions for all the other elements of the vector, and thus represents a second vector-quantized image.

In addition, in some aspects of the technology, the token-critic model may also be used iteratively within a given time-step in order to allow it to converge on a better selection of tokens to be preserved for (or a better selection of tokens to be discarded before) the next time-step. In that regard, in some aspects, following generation of a second plurality of tokens as discussed above, the token-critic model may be used to generate a second plurality of scores based on the second plurality of tokens, and the processing system may then select a second set of one or more tokens of the second plurality of tokens to be preserved based on the second plurality of scores, in which the number of tokens in the second set of tokens is the same as were preserved in the first set of tokens. The generative model may then predict a third plurality of tokens based on the second set of tokens, the third plurality of tokens including the second set of tokens and representing a third vector-quantized image. As will be appreciated, this process may be repeated one or more additional times if further iterations are desired in that time-step. However, if only one extra token-selection iteration is required in the time-step, the token-critic model may then be used to generate a third plurality of scores based on the third plurality of tokens, and the processing system may select a third set of one or more tokens of the third plurality of tokens to be preserved based on the third plurality of scores, in which the number of tokens in the third set of tokens is greater than the number of tokens there were preserved in the first and second sets of tokens.

Further, in some aspects of the technology, the generative models described herein may be configured to predict probability distributions rather than directly predicting each token. In such cases, the generative model may output a probability distribution setting forth, for every possible token, the predicted likelihood that a portion of the image corresponding to that element should be represented by that token. The processing system may then be configured to select which token to use for each element based on the probability distribution for that element. For example, in some aspects, the processing system may select the token for an element by randomly sampling the element's probability distribution, using the predicted likelihoods of each possible token as sampling weights. Likewise, in some aspects, the processing system may analyze the probability distribution for an element and simply select the token having the highest likelihood in that probability distribution.

Employing an independent token-critic model to analyze the output of a non-autoregressive generative model may lead to several benefits. For example, although a non-autoregressive generative model may be configured to generate a confidence score as it generates each token, the token-critic model may be configured to base its scoring on the entire output of a generative model, thus enabling the token-critic model's scores to be holistic, and thus capture spatial and semantic correlations between tokens. In addition, if a non-autoregressive generative model's own scores are used to determine which tokens to preserve for each next time-step, the model will not generate predictions or confidence scores for the preserved tokens during that next time-step, thus ensuring that once a token is selected for preservation, it will survive through to the model's final output, even where those tokens are not well suited to the type of image being generated. This may lead to “locking in” low-quality token predictions, and/or may have an “anchoring” effect in which early predictions tend to overwhelmingly influence the model's final output. In contrast, by using an independent token-critic model, a given token may be preserved in one time-step and discarded in the next, thus allowing earlier predictions to be revised as further predictions are made and as the image “comes into focus” through each successive time-step. As a result, the present technology may be used to preserve some or all of the efficiency benefits of non-autoregressive image models while leading to improvements in both the variability and realism of the images generated by such models. In this way, the present technology may also enable a smaller non-autoregressive image model to generate images of similar or higher quality than a larger non-autoregressive image model, thus leading to faster image generation times and/or the ability to store the model on a wider array of hardware.

In one aspect, the disclosure describes a computer-implemented method of generating an image, comprising: predicting, using a first neural network, a first plurality of probability distributions; generating, using one or more processors of a processing system, a first plurality of tokens based on the first plurality of probability distributions, the first plurality of tokens representing a first vector-quantized image; generating, using a second neural network different than the first neural network, a first plurality of scores based on the first plurality of tokens, each score of the first plurality of scores representing a prediction of whether a token of the first plurality of tokens was generated by a generative model;
selecting, using the one or more processors, a first set of one or more tokens of the first plurality of tokens based on the first plurality of scores; predicting, using the first neural network, a second plurality of probability distributions based on the first set of tokens; and generating, using the one or more processors, a second plurality of tokens based on the second plurality of probability distributions and the first set of tokens, the second plurality of tokens including the first set of tokens and representing a second vector-quantized image. In some aspects, the method further comprises: generating, using the second neural network, a second plurality of scores based on the second plurality of tokens, each score of the second plurality of scores representing a prediction of whether a token of the second plurality of tokens was generated by a generative model; selecting, using the one or more processors, a second set of one or more tokens of the second plurality of tokens based on the second plurality of scores; predicting, using the first neural network, a third plurality of probability distributions based on the second set of tokens; and generating, using the one or more processors, a third plurality of tokens based on the third plurality of probability distributions and the second set of tokens, the third plurality of tokens including the second set of tokens and representing a third vector-quantized image. In some aspects, each token of the third plurality of tokens represents a single pixel of the third vector-quantized image. In some aspects, each token of the second plurality of tokens represents a single pixel of the second vector-quantized image, and each token of the first plurality of tokens represents a single pixel of the first vector-quantized image. In some aspects, each token of the third plurality of tokens represents two or more pixels of the third vector-quantized image. In some aspects, each token of the second plurality of tokens represents two or more pixels of the second vector-quantized image, and each token of the first plurality of tokens represents two or more pixels of the first vector-quantized image. In some aspects, the method further comprises generating the second vector-quantized image based on the second plurality of tokens. In some aspects, the method further comprises generating the third vector-quantized image based on the third plurality of tokens. In some aspects, the first neural network is a transformer. In some aspects, the second neural network is a transformer.

In another aspect, the disclosure describes a non-transitory computer program product comprising computer readable instructions that, when executed by a processing system, cause the processing system to perform any of the methods described in the preceding paragraph.

In another aspect, the disclosure describes a processing system comprising: (1) a memory storing a first neural network and a second neural network, the first neural network being different than the second neural network; and (2) one or more processors coupled to the memory and configured to: predict, using the first neural network, a first plurality of probability distributions; generate a first plurality of tokens based on the first plurality of probability distributions, the first plurality of tokens representing a first vector-quantized image; generate, using the second neural network, a first plurality of scores based on the first plurality of tokens, each score of the first plurality of scores representing a prediction of whether a token of the first plurality of tokens was generated by a generative model; select a first set of one or more tokens of the first plurality of tokens based on the first plurality of scores; predict, using the first neural network, a second plurality of probability distributions based on the first set of tokens; and generate a second plurality of tokens based on the second plurality of probability distributions and the first set of tokens, the second plurality of tokens including the first set of tokens and representing a second vector-quantized image. In some aspects, the one or more processors are further configured to: generate, using the second neural network, a second plurality of scores based on the second plurality of tokens, each score of the second plurality of scores representing a prediction of whether a token of the second plurality of tokens was generated by a generative model; select a second set of one or more tokens of the second plurality of tokens based on the second plurality of scores; predict, using the first neural network, a third plurality of probability distributions based on the second set of tokens; and generate a third plurality of tokens based on the third plurality of probability distributions and the second set of tokens, the third plurality of tokens including the second set of tokens and representing a third vector-quantized image. In some aspects, the one or more processors are further configured to generate the second vector-quantized image based on the second plurality of tokens. In some aspects, the one or more processors are further configured to generate the second vector-quantized image using a decoder of a vector-quantized autoencoder, a decoder of a generative adversarial network, or a decoder of a transformer stored in the memory. In some aspects, the one or more processors are further configured to generate the third vector-quantized image based on the third plurality of tokens. In some aspects, the one or more processors are further configured to generate the third vector-quantized image using a decoder of a vector-quantized autoencoder, a decoder of a generative adversarial network, or a decoder of a transformer stored in the memory. In some aspects, the first neural network is a transformer. In some aspects, the second neural network is a transformer.

In another aspect, the disclosure describes a computer-implemented method of generating an image, comprising: predicting, using a first neural network, a first plurality of tokens representing a first vector-quantized image; generating, using a second neural network different than the first neural network, a first plurality of scores based on the first plurality of tokens, each score of the first plurality of scores representing a prediction of whether a token of the first plurality of tokens was generated by a generative model; selecting, using one or more processors of a processing system, a first set of one or more tokens of the first plurality of tokens based on the first plurality of scores; and predicting, using the first neural network, a second plurality of tokens based on the first set of tokens, the second plurality of tokens including the first set of tokens and representing a second vector-quantized image. In some aspects, the method further comprises: generating, using the second neural network, a second plurality of scores based on the second plurality of tokens, each score of the second plurality of scores representing a prediction of whether a token of the second plurality of tokens was generated by a generative model; selecting, using the one or more processors, a second set of one or more tokens of the second plurality of tokens based on the second plurality of scores; and predicting, using the first neural network, a third plurality of tokens based on the second set of tokens, the third plurality of tokens including the second set of tokens and representing a third vector-quantized image. In some aspects, each token of the third plurality of tokens represents a single pixel of the third vector-quantized image. In some aspects, each token of the second plurality of tokens represents a single pixel of the second vector-quantized image, and each token of the first plurality of tokens represents a single pixel of the first vector-quantized image. In some aspects, each token of the third plurality of tokens represents two or more pixels of the third vector-quantized image. In some aspects, each token of the second plurality of tokens represents two or more pixels of the second vector-quantized image, and each token of the first plurality of tokens represents two or more pixels of the first vector-quantized image. In some aspects, the method further comprises generating the second vector-quantized image based on the second plurality of tokens. In some aspects, the method further comprises generating the third vector-quantized image based on the third plurality of tokens. In some aspects, the first neural network is a transformer. In some aspects, the second neural network is a transformer.

In another aspect, the disclosure describes a non-transitory computer program product comprising computer readable instructions that, when executed by a processing system, cause the processing system to perform any of the methods described in the preceding paragraph.

In another aspect, the disclosure describes a processing system comprising: (1) a memory storing a first neural network and a second neural network, the first neural network being different than the second neural network; and (2) one or more processors coupled to the memory and configured to: predict, using the first neural network, a first plurality of tokens representing a first vector-quantized image; generate, using the second neural network, a first plurality of scores based on the first plurality of tokens, each score of the first plurality of scores representing a prediction of whether a token of the first plurality of tokens was generated by a generative model; select a first set of one or more tokens of the first plurality of tokens based on the first plurality of scores; and predict, using the first neural network, a second plurality of tokens based on the first set of tokens, the second plurality of tokens including the first set of tokens and representing a second vector-quantized image. In some aspects, the one or more processors are further configured to: generate, using the second neural network, a second plurality of scores based on the second plurality of tokens, each score of the second plurality of scores representing a prediction of whether a token of the second plurality of tokens was generated by a generative model; select a second set of one or more tokens of the second plurality of tokens based on the second plurality of scores; and predict, using the first neural network, a third plurality of tokens based on the second set of tokens, the third plurality of tokens including the second set of tokens and representing a third vector-quantized image. In some aspects, the one or more processors are further configured to generate the second vector-quantized image based on the second plurality of tokens. In some aspects, the one or more processors are further configured to generate the second vector-quantized image using a decoder of a vector-quantized autoencoder, a decoder of a generative adversarial network, or a decoder of a transformer stored in the memory. In some aspects, the one or more processors are further configured to generate the third vector-quantized image based on the third plurality of tokens. In some aspects, the one or more processors are further configured to generate the third vector-quantized image using a decoder of a vector-quantized autoencoder, a decoder of a generative adversarial network, or a decoder of a transformer stored in the memory. In some aspects, the first neural network is a transformer. In some aspects, the second neural network is a transformer.

### BRIEF DESCRIPTION OF THE DRAWINGS

FIG. 1 is a functional diagram of an example system in accordance with aspects of the disclosure.

FIG. 2 is a functional diagram of an example system in accordance with aspects of the disclosure.

FIG. 3 is a flow chart illustrating an exemplary process flow for training a token-critic model, in accordance with aspects of the disclosure.

FIGS. 4A and 4B are flow charts illustrating an exemplary process flow for iterative non-autoregressive image synthesis using a generative model and a token-critic model, in accordance with aspects of the disclosure.

FIG. 4C illustrates exemplary images corresponding to the exemplary output vectors produced at each time step t of the process flow of FIGS. 4A and 4B, in accordance with aspects of the disclosure.

FIGS. 5A and 5B are flow charts illustrating an exemplary process flow for iterative non-autoregressive image synthesis using a generative model and a token-critic model, in accordance with aspects of the disclosure.

FIG. 6 sets forth an exemplary method representing a pass through one time-step t into the next time-step t+1 in the exemplary process flows of FIGS. 4A-4B or FIGS. 5A-5B, or a pass within a time-step t from iteration n into iteration n+1 in the exemplary process flow of FIGS. 5A-5B, in accordance with aspects of the disclosure.

FIG. 7 sets forth an exemplary method, building from the method of FIG. 6, for a pass through time-step t+1 into the next time-step t+2 in the exemplary process flow of FIGS. 4A-4B or FIGS. 5A-5B, or a pass within a time-step t from iteration n into iteration n+1 in the exemplary process flow of FIGS. 5A-5B, in accordance with aspects of the disclosure.

FIG. 8 sets forth an exemplary method representing a pass through one time-step t into the next time-step t+1 in the exemplary process flows of FIGS. 4A-4B or FIGS. 5A-5B, or a pass within a time-step t from iteration n into iteration n+1 in the exemplary process flow of FIGS. 5A-5B, in accordance with aspects of the disclosure.

FIG. 9 sets forth an exemplary method, building from the method of FIG. 8, for a pass through time-step t+1 into the next time-step t+2 in the exemplary process flow of FIGS. 4A-4B or FIGS. 5A-5B, or a pass within a time-step t from iteration n into iteration n+1 in the exemplary process flow of FIGS. 5A-5B, in accordance with aspects of the disclosure.

### DETAILED DESCRIPTION

The present technology will now be described with respect to the following exemplary systems and methods. Reference numbers in common between the figures depicted and described below are meant to identify the same features.

### Example Systems

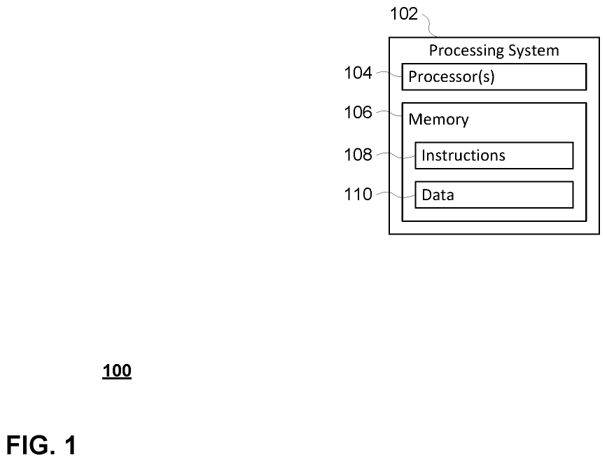

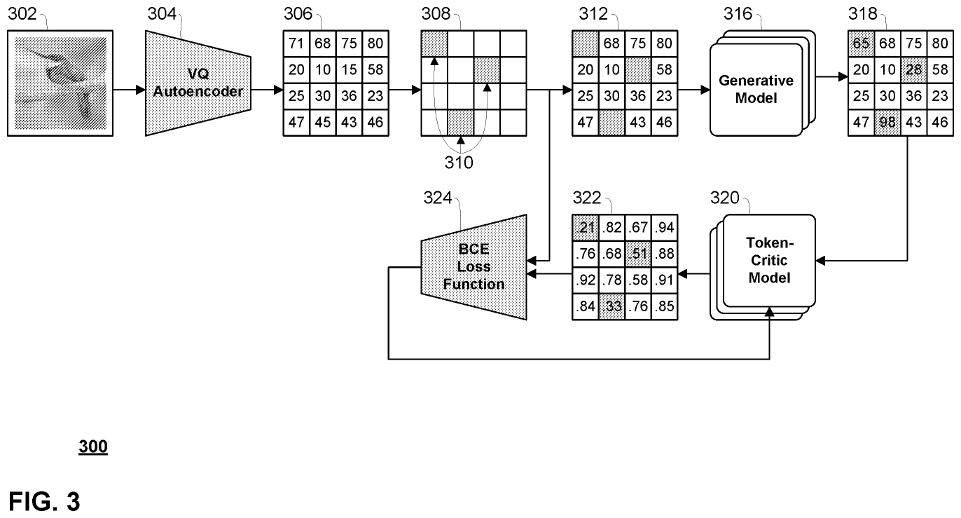

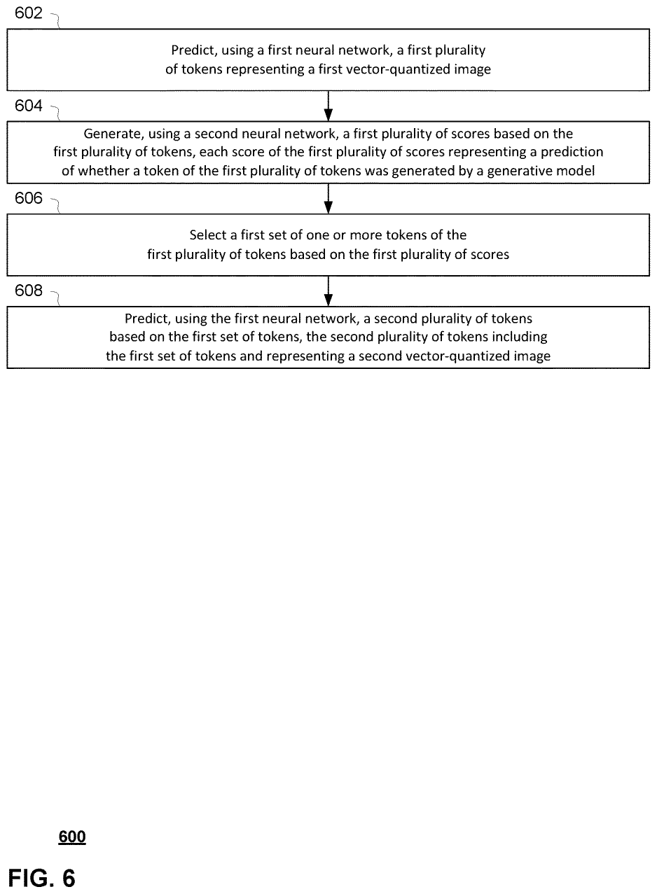

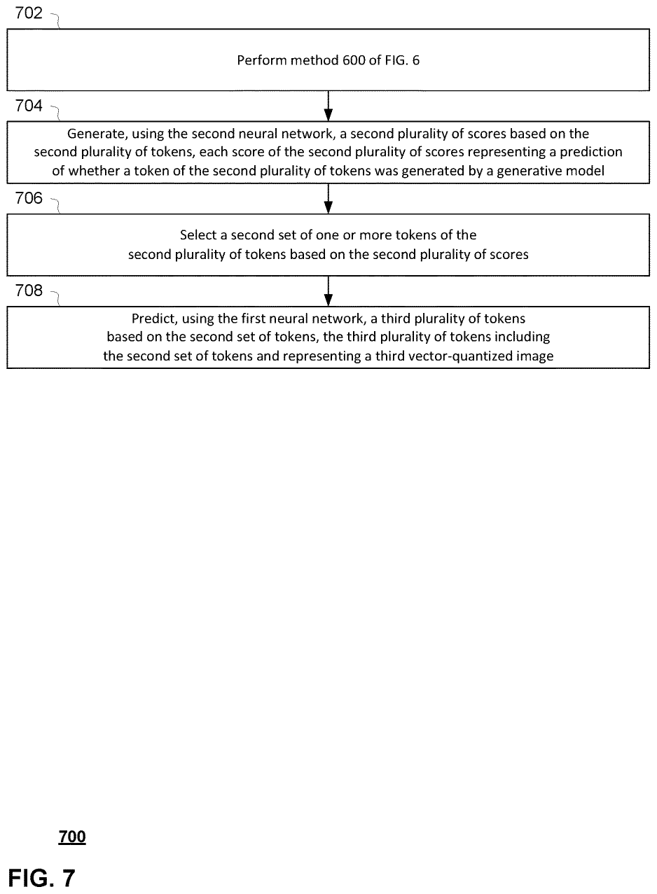

FIG. 1 shows a high-level system diagram 100 of an exemplary processing system 102 for performing the methods described herein. The processing system 102 may include one or more processors 104 and memory 106 storing instructions 108 and data 110. The instructions 108 and data 110 may include a generative model (e.g., the generative model 316/404 of FIGS. 3-5B, the first neural network of FIGS. 6-9, etc.) and/or a token-critic model (e.g., the token-critic model 320/408 of FIGS. 3-5B, the second neural network of FIGS. 6-9), as described further below. In addition, the data 110 may store training examples to be used in training the generative model and/or the token-critic model, outputs from the generative model and/or the token-critic model produced during training, training signals and/or loss values generated during such training, and/or outputs from the generative model and/or the token-critic model generated during training inference.

Processing system 102 may be resident on a single computing device. For example, processing system 102 may be a server, personal computer, or mobile device, and the neural network may thus be local to that single computing device. Similarly, processing system 102 may be resident on a cloud computing system or other distributed system. In such a case, the neural network may be distributed across two or more different physical computing devices. For example, the processing system may comprise a first computing device storing layers 1-n of a generative model and/or a token-critic model having m layers, and a second computing device storing layers n-m of the generative model and/or the token-critic model. In such cases, the first computing device may be one with less memory and/or processing power (e.g., a personal computer, mobile phone, tablet, etc.) compared to that of the second computing device, or vice versa. Likewise, in some aspects of the technology, the processing system may comprise one or more computing devices storing a generative model, and one or more separate computing devices storing a token-critic model. Further, in some aspects of the technology, data used and/or generated during training or inference of a generative model and/or a token-critic model (e.g., training examples, model outputs, loss values, etc.) may be stored on a different computing device than the generative model and/or the token-critic model.

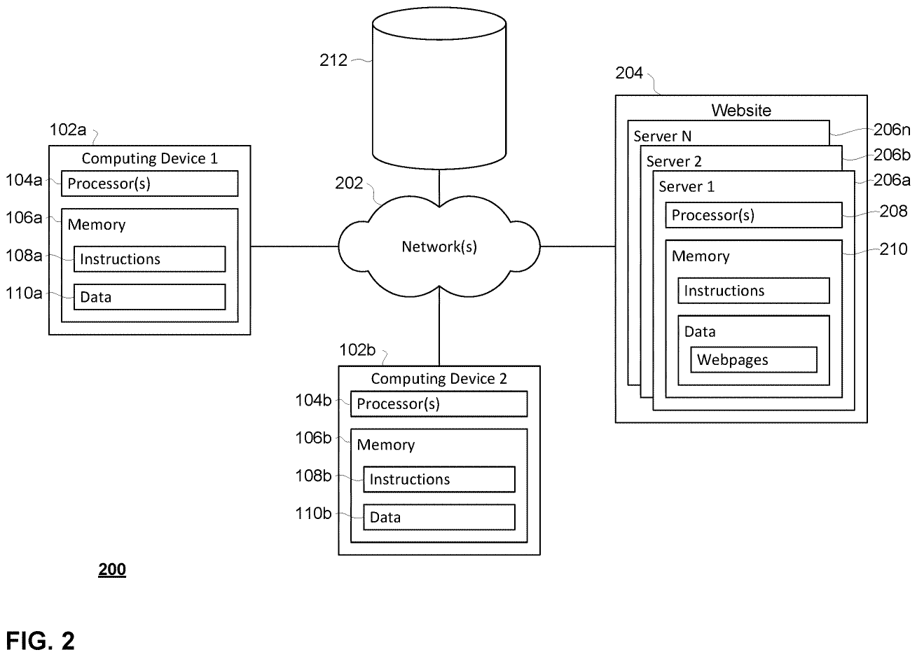

Further in this regard, FIG. 2 shows a high-level system diagram 200 in which the exemplary processing system 102 just described is distributed across two computing devices 102a and 102b, each of which may include one or more processors (104a, 104b) and memory (106a, 106b) storing instructions (108a, 108b) and data (110a, 110b). The processing system 102 comprising computing devices 102a and 102b is shown being in communication with one or more websites and/or remote storage systems over one or more networks 202, including website 204 and remote storage system 212. In this example, website 204 includes one or more servers 206a-206n. Each of the servers 206a-206n may have one or more processors (e.g., 208), and associated memory (e.g., 210) storing instructions and data, including the content of one or more webpages. Likewise, although not shown, remote storage system 212 may also include one or more processors and memory storing instructions and data. In some aspects of the technology, the processing system 102 comprising computing devices 102a and 102b may be configured to retrieve data from one or more of website 204 and/or remote storage system 212, for use during training of a token-critic model. For example, in some aspects, the first computing device 102a may be configured to retrieve training images, and masks to be applied thereto, from the remote storage system 212. Those training images and masks may then be used by a generative model to generate outputs which may be used (along with the masks) as training examples to train a token-critic model housed on the first computing device 102a and/or the second computing device 102b. Further, in such cases, the first computing device 102a may be configured to store one or more of the generated training examples on the remote store system 212, for retrieval by the second computing device 102a. Likewise, in some aspects, the first computing device 102a may be configured to retrieve pre-made training examples (e.g., generative model outputs and masks) from the remote storage system 212 for use in training a token-critic model housed on the first computing device 102a and/or the second computing device 102b.

The processing systems described herein may be implemented on any type of computing device(s), such as any type of general computing device, server, or set thereof, and may further include other components typically present in general purpose computing devices or servers. Likewise, the memory of such processing systems may be of any non-transitory type capable of storing information accessible by the processor(s) of the processing systems. For instance, the memory may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, stylus, touch screen, and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C #, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

### Example Methods

FIG. 3 is a flow chart illustrating an exemplary process flow 300 for training a token-critic model 320, in accordance with aspects of the disclosure.

In that regard, in the exemplary process flow 300 of FIG. 3, an image 302 is converted by a vector-quantized autoencoder 304 into a vector 306. The vector-quantized autoencoder 304 may be any suitable type of learned autoencoder that has been trained to quantize images. Thus, in some aspects of the technology, the vector-quantized autoencoder 304 may be built on a variational autoencoder, GAN, or vision transformer backbone. Likewise, in some aspects of the technology, the vector-quantized autoencoder 304 may be incorporated into another model. For example, the vector-quantized autoencoder 304 may be a part of a generative model, such as the generative model 316/404 of FIGS. 3-5B, or the first neural network of FIGS. 6-9.

Further, the vector-quantized autoencoder 304 may be configured to generate a vector 306 of any suitable type. For example, in some aspects of the technology, the vector-quantized autoencoder 304 may be configured to generate a vector 306 in which each element corresponds to a different pixel of image 302. Likewise, in some aspects of the technology, the vector-quantized autoencoder 304 may be configured to process image 302 according to a grid, with each element of vector 306 corresponding to a group of pixels in a different box of that grid. Thus, in some aspects, image 302 may be a 256×256 pixel image, and vector 306 may be a 256-element vector in which each element corresponds to a different 16×16 block of pixels. Likewise, in some aspects, image 302 may be a 512×512 pixel image, and vector 306 may be a 256-element vector in which each element corresponds to a different 32×32 block of pixels. Moreover, although vector 306 is shown for simplicity in FIG. 3 as a grid or matrix, it will be understood that vector 306 may have any other suitable format. Thus, in some aspects of the technology, the vector-quantized autoencoder 304 may be configured to process image 302 according to a grid, but to output a vector 306 that represents that grid as a flattened sequence of tokens (e.g., the sequence of tokens resulting from parsing the grid using a left-to-right, top-to-bottom approach).

In addition, vector 306 may also include values of any type suitable for representing a portion of an image. Thus, in some aspects of the technology, each element of vector 306 may be an integer value corresponding to a particular arrangement of one or more pixels. In such cases, all possible pixel arrangements and their corresponding integer values may be stored in a separate codebook. For example, in some aspects, the vector-quantized autoencoder 304 may be configured to process image 302, identify a predetermined number of possible pixel arrangements (e.g., 1024 different pixel arrangements) in the image 302, generate a codebook correlating each of the identified pixel arrangements with a different integer value (e.g., integers 1 through 1024), and then fill each element of vector 306 with one of those integer values. Likewise, in some aspects, the vector-quantized autoencoder 304 may be configured to process image 302, identify some number of different pixel arrangements, and then generate a vector 306 in which each element directly includes one of those possible pixel arrangements. In such a case, vector 306 may be a matrix in which each element is itself a vector listing the values for whatever arrangement of pixels has been assigned to that element by the vector-quantized autoencoder 304. In all cases, the vector-quantized autoencoder 304 may be configured to process image 302 using a lossless paradigm, or a lossy paradigm in which the token assigned to a particular box of the grid may represent an arrangement of pixels that does not perfectly match those of the original image 302.

As shown in FIG. 3, following the generation of vector 306, the processing system (e.g., processing system 102 of FIGS. 1 and 2) will apply a mask 308 to vector 306 in order to generate a masked vector 312. In the example of FIG. 3, the mask 308 has the same dimension as vector 306, and includes three shaded boxes 310 representing elements that are to be masked. However, any suitable number of elements may be masked. Moreover, it may be advantageous when training the token-critic model 320 to provide training examples representing a range of possible masking rates (e.g. the number or percentage of elements masked), so that the token-critic model 320 does not become biased as to any particular masking rate(s).

The processing system may apply masking to vector 306 in any suitable way. For example, in some aspects of the technology, the mask 308 may itself be a vector having the same dimension as vector 306, in which every element is either a 1 or a 0. The processing system may then be configured to multiply the vector 306 by the mask 308, so that every element of mask 308 that has a value of 0 will cause the corresponding element of masked vector 312 to likewise have a value of 0, and every element of mask 308 that has a value of 1 will cause the token held in the corresponding element of vector 306 to be passed into masked vector 312. In such a case, every white (unshaded) box of mask 308 would represent an element having a value of 1, and every shaded box 310 would represent an element having a value of 0. However, any other suitable masking procedure may be used. Thus, in some aspects of the technology, the processing system may simply be configured to generate the masked vector 312 by randomly changing one or more elements of vector 306 to a predetermined value indicative of a mask (e.g., 0, −1, etc.) or to a predetermined mask token (e.g., “[MASK]”). In such a case, the processing system may record which elements were masked so as to create a list or vector representing mask 308.

Following the creation of masked vector 312, the processing system will provide the masked vector 312 to the generative model 316 in order to predict tokens for each of the masked elements. Based on the generative model 316's predictions, an output vector 318 will be created which includes the tokens of masked vector 312 for all unmasked (white) elements, and the predicted tokens for all masked (shaded) elements. Here as well, although the output vector 318 is shown for simplicity as a grid or matrix of the same size and arrangement as vector 306 and masked vector 312, it will be understood that the output vector 318 may have any other suitable format. Thus, in some aspects of the technology, the generative model 316 may be configured to produce an output vector 318 that simply represents a flattened sequence of tokens.

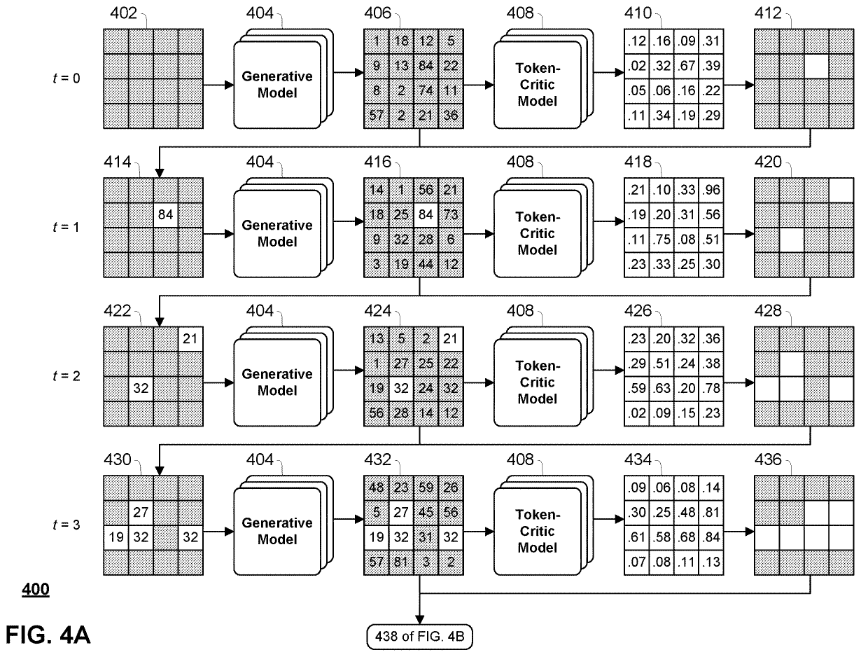

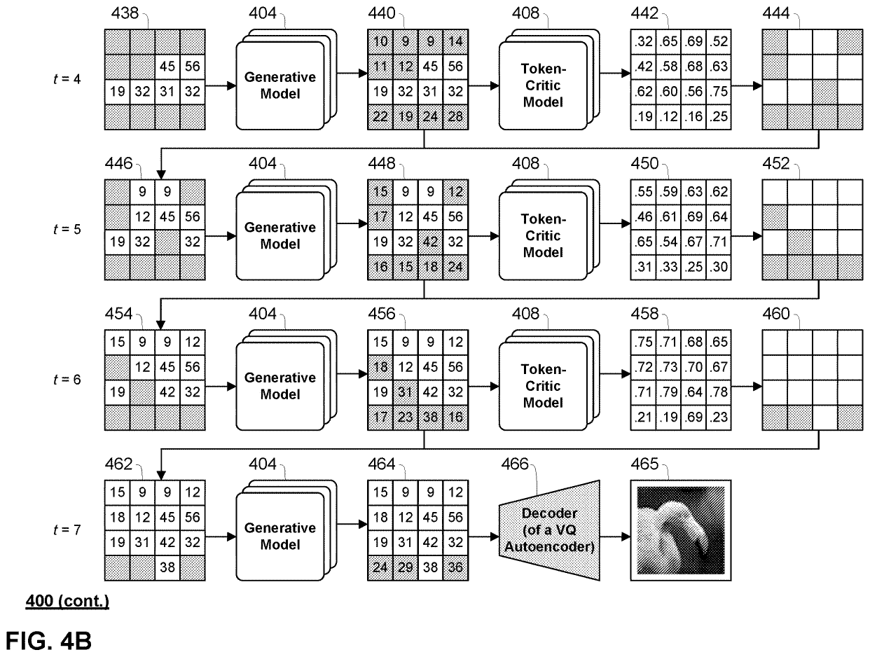

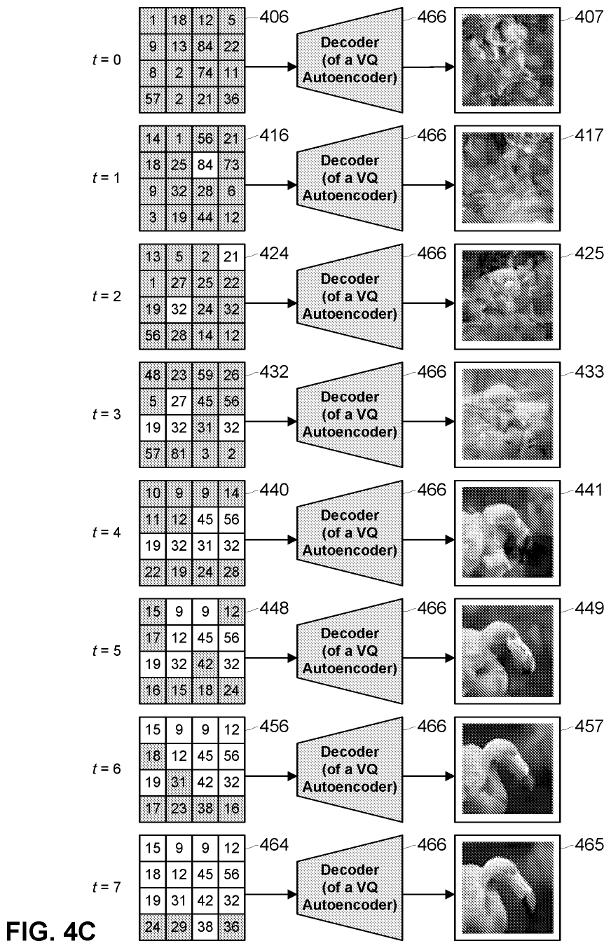

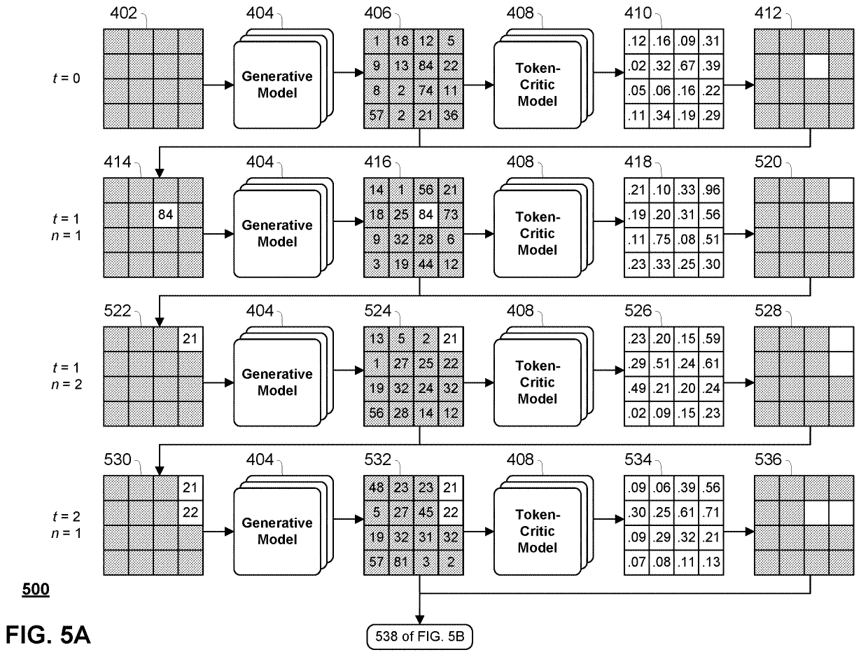

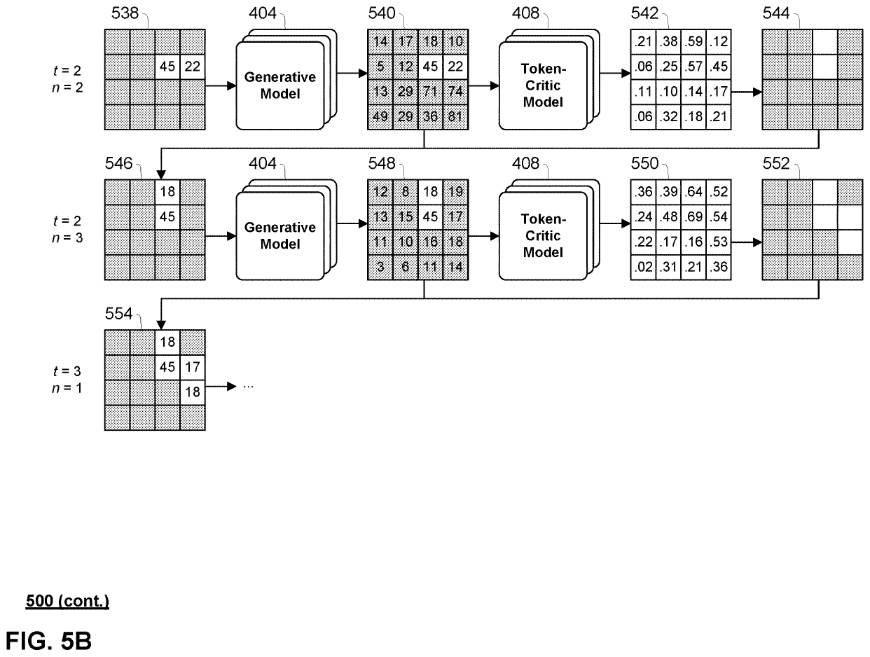

Although the exemplary process flow 300 of FIG. 3 shows the generative model 316 receiving only the masked vector 312, in some aspects of the technology, additional information may be provided to the generative model 316 (or to the generative model 404 of FIGS. 4-5B, and the first neural network of FIGS. 6-9) for use in making its predictions. For example, in some aspects of the technology, the generative model 316 may be configured to receive an additional class identifier that indicates the type of image (e.g., animal, person, building, landscape, etc.) the generative model 316 is to produce. In such cases, the class identifier may be provided to the generative model 316 as a separate input, or may be appended to the masked vector 312.

The predicted tokens included in output vector 318 may be generated directly or indirectly on the outputs of the generative model 316. Thus, in some aspects of the technology, the generative model 316 may be configured to directly predict a single token for each of the masked elements of masked vector 312, and those predicted tokens may then be included in output vector 318. Likewise, in some aspects of the technology, the generative model 316 may be configured to predict two or more possible tokens for each of the masked elements of masked vector 312, and the processing system may then be configured to select one of those predicted possible tokens for inclusion in output vector 318 using a suitable selection paradigm. For example, the generative model 316 may be configured to generate a probability distribution for each masked element of masked vector 312, where the distribution represents, for every possible token (e.g., every entry in the codebook generated by the vector-quantized autoencoder 304), a predicted likelihood that the masked element would have that token. In such a case, the processing system may then be configured to select a token for each masked element of masked vector 312 based on that element's probability distribution (e.g., by randomly sampling the element's probability distribution using the predicted likelihoods of each possible token as sampling weights, or by selecting the token that has the highest likelihood in the element's probability distribution).

The generative model 316 of FIG. 3 may be a trained non-autoregressive transformer or discrete diffusion model based on a standard transformer architecture, bidirectional encoder transformer architecture, or any other suitable transformer architecture. Likewise, the generative model 316 may be of any suitable size and number of parameters, and may have been trained to predict masked tokens (or probability distributions for masked tokens) in any suitable way. Thus, for example, the generative model 316 may be a non-autoregressive transformer or discrete diffusion model built on a bidirectional encoder transformer architecture with 24 layers and 16 attention heads, configured to use embeddings of dimension 768 and a hidden dimension of 3072, and trained using a suitable number of masked modeling tasks (e.g., 600 epochs with a batch size of 256).

After the generative model 316 has produced the output vector 318, the output vector 318 may be used to train a separate token-critic model 320. In that regard, as shown in FIG. 3, the token-critic model 320 will generate a scoring vector 322 based on the output vector 318. The scoring vector 322 is a vector representing the token-critic model 320's prediction, for every given element of the output vector 318, regarding whether the token corresponding to the given element was or was not generated by a generative model. For simplicity of illustration, in this example, each element of the scoring vector 322 is shown having a two-digit decimal between 0 and 1. It is further assumed in this example (as well as the examples of FIGS. 4-5B) that higher values indicate a prediction that the token in question is more likely to be a “real” token (e.g., one pulled directly from vector 306) and that lower values indicate a prediction that the token in question is more likely to have been generated by a generative model (e.g., one generated by generative model 316). However, the token-critic model 320 may be configured to use any suitable scoring paradigm, and any suitable range and precision of scoring values. Moreover, although scoring vector 322 is shown for simplicity in FIG. 3 as a grid or matrix of the same size and arrangement as vector 306 and output vector 318, it will be understood that scoring vector 322 may have any other suitable format. Thus, in some aspects of the technology, the token-critic model 320 may be configured to output a scoring vector 322 that simply represents a flattened sequence of scoring values.

Here as well, the token-critic model 320 of FIG. 3 may be based on any suitable neural network architecture, such as a standard transformer architecture or bidirectional encoder transformer architecture, and may be of any suitable size and number of parameters. Thus, for example, the token-critic model 320 may be built on a bidirectional encoder transformer architecture with 20 layers and 12 attention heads, configured to use embeddings of dimension 768 and a hidden dimension of 3072, and trained as further described herein using a suitable number of training examples (e.g., 300 epochs with a batch size of 256).

After the token-critic model 320 produces the scoring vector 322, it may be used directly or indirectly to generate one or more loss values for use in tuning the parameters of the token-critic model 320. For example, the loss values may be generated using any suitable loss function that compares the scoring vector 322 to the mask 308, penalizing incorrect predictions and/or rewarding correct predictions. Thus, in the example of FIG. 3, a binary cross-entropy loss function 324 is configured to compare the scoring vector 322 to the mask 308 to generate a binary-cross entropy loss value that represents the accuracy of the token-critic model 320's predictions for that training example. Likewise, it will be appreciated that other types of classification loss may alternatively be used. The resulting loss value may then be used to update one or more parameters of the token-critic model 320. These backpropagation steps may be performed at any suitable interval. Thus, in some aspects of the technology, the parameters of the token-critic model 320 may be updated after each training example. Likewise, in some aspects of the technology, multiple training examples may be batched together, with backpropagation occurring at the conclusion of each batch. Further, where multiple training examples are batched, the loss values generated for each training example of the batch may also be combined (e.g., summed, averaged, etc.) into an aggregate loss value, such that the parameters of the token-critic model 320 may be updated based on the aggregate loss value.

FIGS. 4A and 4B are flow charts illustrating an exemplary process flow 400 for iterative non-autoregressive image synthesis using a generative model 404 and a token-critic model 408, in accordance with aspects of the disclosure. FIG. 4C illustrates exemplary images corresponding to the exemplary output vectors produced at each time step t of the process flow of FIGS. 4A and 4B, in accordance with aspects of the disclosure.

The exemplary process flow 400 of FIGS. 4A and 4B begins in time-step t=0 with a first masked vector 402 for which every element is masked (shown as shaded boxes). This first masked vector 402 may have any suitable format and dimension, as described above with respect to the masked vector 312 of FIG. 3. Thus, although the first masked vector 402 is shown in the exemplary process flow 400 of FIGS. 4A and 4B as a 4×4 grid or matrix, it will be understood that it may also be formatted as a flattened sequence of any suitable number of tokens. Likewise, the first masked vector 402 may be masked in any suitable way, with each shaded box representing an element that has been assigned some predetermined masking value (e.g., 0,−1, etc.) or some predetermined masking token (e.g., “[MASK]”).

As shown in FIG. 4A, the first masked vector 402 is provided to a generative model 404, which then generates a prediction for every masked element of the first masked vector 402. A first output vector 406 including a token for every masked element is then generated based (directly or indirectly) on the predictions of the generative model 404. The first output vector 406 will thus include a first plurality of tokens, which together represent a first vector-quantized image. In that regard, as illustrated in FIG. 4C, if the first plurality of tokens were to be processed through a decoder of a vector-quantized autoencoder 466, they may produce a corresponding image such as image 407.

Here as well, although the first output vector 406 is shown in the exemplary process flow 400 of FIGS. 4A and 4B as a 4×4 grid or matrix, it will be understood that it may also be formatted as a flattened sequence of any suitable number of tokens. Likewise, although the first output vector 406 is shown in FIG. 4A having integer values between 1 and 99 for simplicity, it may include values of any type suitable for representing a portion of an image. Thus, in some aspects of the technology, the generative model 404 may be configured to produce output vectors (e.g., first output vector 306) in which each element is an integer value (e.g., an integer between 1 and 1024) corresponding to a particular arrangement of one or more pixels (e.g., 16×16 blocks of pixels, 32×32 blocks of pixels). In such cases, all possible pixel arrangements and their corresponding integer values may be stored in a separate codebook. Likewise, in some aspects, the generative model 404 may be configured to produce output vectors (e.g., first output vector 306) in which each element directly includes one of those possible pixel arrangements. In such a case, the first output vector 306 may be a matrix in which each element is itself a vector listing the values for whatever arrangement of pixels has been predicted (or sampled) for that element.

The vector-quantized autoencoder 466 shown in FIGS. 4B and 4C may be any suitable type of learned autoencoder that has been trained to quantize images, including any of the options described above with respect to the vector-quantized autoencoder 304 of FIG. 3.

The generative model 404 of FIGS. 4A-5B may also be of the same type and configuration as the generative model 316 of FIG. 3, as described above. Similarly, the generative model 404 may be configured to make its predictions in any of the ways described above with respect to generative model 316. Thus, in some aspects of the technology, the generative model 404 may be configured to directly predict a single token for each of the masked elements of a given masked vector (e.g., first masked vector 402), and those predicted tokens may then be included in the resulting output vector (e.g., first output vector 406). Likewise, in some aspects of the technology, the generative model 404 may be configured to predict two or more possible tokens for each of the masked elements of a given masked vector (e.g., first masked vector 402), and the processing system (e.g., processing system 102 of FIGS. 1 and 2) may then be configured to select one of those predicted possible tokens for inclusion in the resulting output vector (e.g., first output vector 406) using a suitable selection paradigm. For example, the generative model 404 may be configured to generate a probability distribution for each masked element of first masked vector 402, where the distribution represents, for every possible token, a predicted likelihood that the masked element would have that token. In such a case, the processing system may then be configured to select a token for each masked element of the first masked vector 402 based on that element's probability distribution (e.g., by randomly sampling the element's probability distribution using the predicted likelihoods of each possible token as sampling weights, or by selecting the token that has the highest likelihood in the element's probability distribution), and to include the selected token in the resulting first output vector 406.

Here as well, although each time-step of the exemplary process flow 400 of FIGS. 4A and 4B shows the generative model 404 receiving only a masked vector as input, in some aspects of the technology, additional information may be provided to the generative model 404 for use in making its predictions. For example, in some aspects of the technology, the generative model 404 may be configured to receive an additional class identifier that indicates the type of image (e.g., animal, person, building, landscape, etc.) the generative model 404 is to produce. In such cases, the class identifier may be provided to the generative model 404 as a separate input, or may be appended to each masked vector.

Following the generation of the first output vector 406, a token-critic model 408 will generate a first scoring vector 410 based on the first output vector 406. The first scoring vector 410 is a vector representing the token-critic model 408's prediction, for every given element of the first output vector 406, regarding whether the token corresponding to the given element was or was not generated by a generative model. Here as well, for simplicity of illustration, each element of the first scoring vector 410 is shown having a two-digit decimal between 0 and 1, with the assumption being that higher values indicate a prediction that the token in question is more likely to be a “real” token, and that lower values indicate a prediction that the token in question is more likely to have been generated by a generative model. However, the token-critic model 408 may be configured to use any suitable scoring paradigm, and any suitable range and precision of scoring values. Likewise, although the first scoring vector 410 is shown in the exemplary process flow 400 of FIGS. 4A and 4B as a 4×4 grid or matrix, it will be understood that it may also be formatted as a flattened sequence of any suitable number of scores.

The token-critic model 408 of FIGS. 4A-5B may be of the same type and configuration as the token-critic model 320 of FIG. 3, as described above. Likewise, the token-critic model 408 may be trained in the same way as token-critic model 320.

In the exemplary process flow 400 of FIGS. 4A and 4B, in each time-step, following generation of a scoring vector, the processing system will select one or more tokens of the corresponding output vector to be preserved for the next time-step. The processing system will make this selection based (directly or indirectly) on the scores of the scoring vector, and may do so according to any suitable selection paradigm. Thus, in some aspects of the technology, the processing system may be configured to select a set of one or more tokens having the most favorable scores (e.g., the highest values) in the scoring vector for that time-step. An example of this is shown in FIG. 4A, where in time-step t=0, the processing system selects a single token to be passed onto the next time-step. This selection is illustrated in a corresponding illustrative first mask 412, in which the element corresponding to that token is shown in white. As can be seen, the token selected for preservation is the one having the highest score (0.67) in the first scoring vector 410.

However, in some aspects of the technology, the processing system may select which tokens to preserve for the next time-step based indirectly on the scores of the scoring vector. For example, in some aspects, the processing system may first modify the scoring vector (e.g., by introducing noise into the scoring vector in order to randomize the scores), and then may select a set of one or more tokens having the most favorable scores (e.g., the highest values) in that modified scoring vector. Moreover, in some aspects of the technology, the processing system may be configured to choose whether and how much to modify the scoring vector based on the time-step. For example, in some aspects, the processing system may be configured to only introduce noise into the scoring vector during the first time-step or the first n time-steps, and to make selections based directly on the scoring vector for each time-step thereafter.

In addition, the processing system may be configured to determine how many tokens to select in each time-step based on any suitable criteria. Thus, in some aspects, the processing system may be configured to follow a predetermined masking schedule that dictates how many tokens will be preserved in each time-step. Likewise, in some aspects, the processing system may be configured to determine on-the-fly how many tokens to preserve in a given time-step. For example, in some aspects, the processing system may determine how many tokens to preserve in a given time-step by selecting all tokens that were scored above a certain threshold. Similarly, in some aspects, the processing system may determine how many tokens to select in a given time-step by preserving up to some predetermined number of tokens having a score above a certain threshold.

Although the exemplary process flow 400 of FIGS. 4A and 4B shows an illustrative mask (e.g., first mask 412) in each time-step, the processing system may apply masking to the corresponding output vector (e.g., first output vector 406) in any suitable way (e.g., with or without actually generating a mask). For example, in some aspects of the technology, the first mask 412 may itself be a vector having the same dimension as the first output vector 406, in which every element is either a 1 or a 0. The processing system may then be configured to multiply the first output vector 406 by the first mask 412, so that every element of first mask 412 that has a value of 0 will cause the corresponding element of the second masked vector 414 to likewise have a value of 0, and every element of first mask 412 that has a value of 1 will cause the token held in the corresponding element of the first output vector 406 to be passed directly into the second masked vector 414. In such a case, every white box of first mask 412 would represent an element having a value of 1, and every shaded box of first mask 412 would represent an element having a value of 0. However, any other suitable masking procedure may be used. Thus, in some aspects of the technology, the processing system may be configured to simply parse the first scoring vector 410 (or a modified version thereof) and replace all but the top n values with a predetermined value (e.g., 0,−1, etc.) or to a predetermined mask token (e.g., “[MASK]”). Further, although the first mask 412 is shown in the exemplary process flow 400 of FIGS. 4A and 4B as a 4×4 grid or matrix, where an masking vector is actually generated, it will be understood that it may also be formatted as a flattened sequence of any suitable number of elements.

Time-step t=1 of the exemplary process flow 400 of FIGS. 4A and 4B follows the same procedure as time-step t=0, with the one exception being that it begins with a second masked vector 414 in which the tokens (e.g., the one token shown in white, with a value of 84) are preserved from the first output vector 406 of the prior time-step. As such, when the second masked vector 414 is provided to the generative model 404 in time-step t=1, the generative model 404 will generate predictions as to the masked elements (shown as shaded boxes) based on the one or more unmasked tokens. The resulting second output vector 416 will thus represent a second plurality of tokens that includes the token preserved from the first output vector 406 and a set of tokens based on the generative model 404's predictions for all masked elements of the second masked vector 414. Here as well, the tokens of the second output vector 416 corresponding to each masked element of the second masked vector 414 may be directly predicted by the generative model 404, or may be indirectly based on the predictions of the generative model 404 (e.g., they may be tokens selected by sampling probability distributions predicted by the generative model 404 for each masked element). The second output vector 416 will then be scored by the token-critic model 408 to generate a second scoring vector 418, which is then used to select a second set of tokens of the second output vector 416 to be preserved for the next time-step. In this example, it is assumed that the processing system is configured to select the two highest-rated tokens (having scores of 0.96 and 0.75), which correspond to the white boxes of the illustrative second mask 420. Notably, a comparison of the elements preserved in time-step t=0 and t=1 illustrates how the present technology enables the model to flexibly revise which tokens to keep from one time-step to the next, as the token that was preserved in time-step t=0 ends up being masked again at the conclusion of time-step t=0. Here again, although the exemplary process flow 400 of FIGS. 4A and 4B shows a mask in each time-step for illustrative purposes, the processing system may select a second set of tokens from the second output vector 416 to be preserved in the next-time step in any suitable way, including ways which do not require generation of a second mask 420.

Time-step t=2 of the exemplary process flow 400 of FIGS. 4A and 4B follows the same procedure as the prior time-steps, but begins with a third masked vector 422 in which two tokens (shown in white, with values of 21 and 32) are preserved from the second output vector 416 of the prior time-step. Here as well, when the third masked vector 422 is provided to the generative model 404 in time-step t=2, the generative model 404 will generate predictions as to the masked elements (shown as shaded boxes) based on the unmasked tokens. The resulting third output vector 424 will thus represent a third plurality of tokens that includes the two tokens preserved from the second output vector 416 and a set of tokens based on the generative model 404's predictions for all masked elements of the third masked vector 422. Here as well, the tokens of the third output vector 424 corresponding to each masked element of the third masked vector 422 may be directly predicted by the generative model 404, or may be indirectly based on the predictions of the generative model 404 (e.g., they may be tokens selected by sampling probability distributions predicted by the generative model 404 for each masked element). The third output vector 424 will then be scored by the token-critic model 408 to generate a third scoring vector 426, which is then used to select a third set of tokens of the third output vector 424 to be preserved for the next time-step. In this example, it is assumed that the processing system is configured to select the four highest-rated tokens (having scores of 0.51, 0.59, 0.63, and 0.78), which correspond to the white boxes of the illustrative third mask 428. As above, a comparison of the elements preserved in time-step t=1 and t=2 again illustrates how the present technology enables the model to flexibly revise which tokens to keep from one time-step to the next, as one of the two tokens that were preserved in time-step t=1 (i.e., the token in the top right corner) ends up being masked again at the conclusion of time-step t=2. In addition, a comparison of the scores generated by the token-critic model 408 in time-step t=1 and t=2 also illustrates how a preserved token may not necessarily end up receiving the same score from one time-step to the next, as the other token preserved in time-step t=1 (i.e., the token in the third row, second column) receives a higher score in time-step t=1 than it receives in time-step t=2. This may result from the fact that the token-critic model's scores are based on the entire output vector, and thus reflect how realistic each token appears in view of all the other tokens of the output vector. Thus, in this case, the lowered score for the token at row 3, column 2 may indicate that the generative model 404's predictions in time-step t=2 resulted in a third output vector 424 for which token “32” seemed (to the token-critic model 408) to be less realistic.

Time-step t=3 of the exemplary process flow 400 of FIGS. 4A and 4B follows the same procedure as the prior time-steps, but begins with a fourth masked vector 430 in which four tokens (shown in white, with values of 27, 19, 32, and 32) are preserved from the third output vector 424 of the prior time-step. Here as well, when the fourth masked vector 430 is provided to the generative model 404 in time-step t=3, the generative model 404 will generate predictions as to the masked elements (shown as shaded boxes) based on the unmasked tokens. The resulting fourth output vector 432 will thus represent a fourth plurality of tokens that includes the four tokens preserved from the third output vector 424 and a set of tokens based on the generative model 404's predictions for all masked elements of the fourth masked vector 430. Here as well, the tokens of the fourth output vector 432 corresponding to each masked element of the fourth masked vector 430 may be directly predicted by the generative model 404, or may be indirectly based on the predictions of the generative model 404 (e.g., they may be tokens selected by sampling probability distributions predicted by the generative model 404 for each masked element). The fourth output vector 432 will then be scored by the token-critic model 408 to generate a fourth scoring vector 434, which is then used to select a fourth set of tokens of the fourth output vector 432 to be preserved for the next time-step. In this example, it is assumed that the processing system is configured to select the six highest-rated tokens (having scores of 0.48, 0.81, 0.61, 0.58, 0.68, and 0.84), which correspond to the white boxes of the illustrative fourth mask 436.

Time-step t=4 of the exemplary process flow 400 of FIGS. 4A and 4B follows the same procedure as the prior time-steps, but begins with a fifth masked vector 438 in which six tokens (shown in white, with values of 45, 56, 19, 32, 31, and 32) are preserved from the fourth output vector 432 of the prior time-step. Here as well, when the fifth masked vector 438 is provided to the generative model 404 in time-step t=4, the generative model 404 will generate predictions as to the masked elements (shown as shaded boxes) based on the unmasked tokens. The resulting fifth output vector 440 will thus represent a fifth plurality of tokens that includes the six tokens preserved from the fourth output vector 432 and a set of tokens based on the generative model 404's predictions for all masked elements of the fifth masked vector 438. Here as well, the tokens of the fifth output vector 440 corresponding to each masked element of the fifth masked vector 438 may be directly predicted by the generative model 404, or may be indirectly based on the predictions of the generative model 404 (e.g., they may be tokens selected by sampling probability distributions predicted by the generative model 404 for each masked element). The fifth output vector 440 will then be scored by the token-critic model 408 to generate a fifth scoring vector 442, which is then used to select a fifth set of tokens of the fifth output vector 440 to be preserved for the next time-step. In this example, it is assumed that the processing system is configured to select the eight highest-rated tokens (having scores of 0.65, 0.69, 0.58, 0.68, 0.63, 0.62, 0.60, 0.75), which correspond to the white boxes of the illustrative fifth mask 444.

Time-step t=5 of the exemplary process flow 400 of FIGS. 4A and 4B follows the same procedure as the prior time-steps, but begins with a sixth masked vector 446 in which eight tokens (shown in white, with values of 9, 9, 12, 45, 56, 19, 32, and 32) are preserved from the fifth output vector 440 of the prior time-step. Here as well, when the sixth masked vector 446 is provided to the generative model 404 in time-step t=5, the generative model 404 will generate predictions as to the masked elements (shown as shaded boxes) based on the unmasked tokens. The resulting sixth output vector 448 will thus represent a sixth plurality of tokens that includes the eight tokens preserved from the fifth output vector 440 and a set of tokens based on the generative model 404's predictions for all masked elements of the sixth masked vector 446. Here as well, the tokens of the sixth output vector 448 corresponding to each masked element of the sixth masked vector 446 may be directly predicted by the generative model 404, or may be indirectly based on the predictions of the generative model 404 (e.g., they may be tokens selected by sampling probability distributions predicted by the generative model 404 for each masked element). The sixth output vector 448 will then be scored by the token-critic model 408 to generate a sixth scoring vector 450, which is then used to select a sixth set of tokens of the sixth output vector 448 to be preserved for the next time-step. In this example, it is assumed that the processing system is configured to select the ten highest-rated tokens (having scores of 0.55, 0.59, 0.63, 0.62, 0.61, 0.69, 0.64, 0.65, 0.67, 0.71), which correspond to the white boxes of the illustrative sixth mask 452.

Time-step t=6 of the exemplary process flow 400 of FIGS. 4A and 4B follows the same procedure as the prior time-steps, but begins with a seventh masked vector 454 in which ten tokens (shown in white, with values of 15, 9, 9, 12, 12, 45, 56, 19, 42, 32) are preserved from the sixth output vector 448 of the prior time-step. Here as well, when the seventh masked vector 454 is provided to the generative model 404 in time-step t=6, the generative model 404 will generate predictions as to the masked elements (shown as shaded boxes) based on the unmasked tokens. The resulting seventh output vector 456 will thus represent a seventh plurality of tokens that includes the ten tokens preserved from the sixth output vector 448 and a set of tokens based on the generative model 404's predictions for all masked elements of the seventh masked vector 454. Here as well, the tokens of the seventh output vector 456 corresponding to each masked element of the seventh masked vector 454 may be directly predicted by the generative model 404, or may be indirectly based on the predictions of the generative model 404 (e.g., they may be tokens selected by sampling probability distributions predicted by the generative model 404 for each masked element). The seventh output vector 454 will then be scored by the token-critic model 408 to generate a seventh scoring vector 458, which is then used to select a seventh set of tokens of the seventh output vector 456 to be preserved for the next time-step. In this example, it is assumed that the processing system is configured to select the thirteen highest-rated tokens (having scores of 0.75, 0.71, 0.68, 0.65, 0.72, 0.73, 0.70, 0.67, 0.71, 0.79, 0.64, 0.78, and 0.69), which correspond to the white boxes of the illustrative seventh mask 460.

In the exemplary process flow 400 of FIGS. 4A and 4B, it is assumed that final images will be generated after eight time-steps, making time-step t=7 the final time-step. However, in some aspects of the technology, the exemplary process flow 400 may be shortened or extended to employ any other suitable number of time-steps (e.g., 2, 5, 10, 13, 18, 24, 36, etc.). As shown in FIG. 4B, time-step t=7 begins with an eighth masked vector 462 in which thirteen tokens (shown in white, with values of 15, 9, 9, 12, 18, 12, 45, 56, 19, 31, 42, 32, and 38) are preserved from the seventh output vector 456 of the prior time-step. Here as well, when the eighth masked vector 462 is provided to the generative model 404 in time-step t=7, the generative model 404 will generate predictions as to the masked elements (shown as shaded boxes) based on the unmasked tokens. The resulting eighth output vector 464 will thus represent an eighth plurality of tokens that includes the thirteen tokens preserved from the seventh output vector 456 and a set of tokens based on the generative model 404's predictions for all masked elements of the eighth masked vector 462. Here as well, the tokens of the eighth output vector 464 corresponding to each masked element of the eighth masked vector 462 may be directly predicted by the generative model 404, or may be indirectly based on the predictions of the generative model 404 (e.g., they may be tokens selected by sampling probability distributions predicted by the generative model 404 for each masked element). In this case, as t=7 represents the final time-step, the eighth output vector 464 will not be scored by the token-critic model 408. Rather, the eighth output vector 464 will be processed through the decoder of the vector-quantized autoencoder 466 to produce a corresponding final image 465.

As already mentioned, the exemplary process flow 400 of FIGS. 4A and 4B allows the generative model 404 to iteratively synthesize a series of images in a flexible manner, where tokens preserved in one time-step may be discarded in favor of new predictions in the next time-step. Exemplary results of this process are shown in FIG. 4C, which illustrates how the output vectors produced in each time-step of the exemplary process flow 400 might appear. In particular, images 407, 417, 425, 433, 441, 449, 457, and 465 show what might result if the output vectors 406, 416, 424, 432, 440, 448, 456, and 464 were to be processed using the decoder of the vector-quantized autoencoder 466.

FIGS. 5A and 5B are flow charts illustrating another exemplary process flow 500 for iterative non-autoregressive image synthesis using a generative model 404 and a token-critic model 408, in accordance with aspects of the disclosure. In that regard, the exemplary process flow 500 of FIGS. 5A and 5B is similar to the exemplary process flow 400 of FIGS. 4A and 4B, but shows an optional paradigm in which the token-critic model 408 is applied iteratively within certain time-steps in order to allow the token-critic model 408 to converge on a better selection of tokens to be preserved for (or a better selection of tokens to be discarded before) the next time-step.

For simplicity, the generative model 404 and token-critic model 408 of FIGS. 5A and 5B are meant to be the same as those of FIGS. 4A and 4B, and may be configured according to any of the options described above. Likewise, in FIGS. 5A and 5B, each of the masked vectors (402, 414, 522, 530, 538, 546, 554), output vectors (406, 416, 524, 532, 540, 548), scoring vectors (410, 418, 526, 534, 542, 550), and illustrative masks (412, 520, 528, 536, 544, 552) may be configured, generated, and/or used according to any of the options described above with respect to the masked vectors (402, 414, 422, 430, 438, 446, 454, 462), output vectors (406, 416, 424, 432, 440, 448, 456, 464), scoring vectors (410, 418, 426, 434, 442, 450, 458), and illustrative masks (412, 420, 428, 436, 444, 452, 460) of FIGS. 4A and 4B. Further, although the exemplary process flow 500 of FIGS. 5A and 5B shows an illustrative mask in each iteration of each time-step, the processing system may apply masking to the corresponding output vector in any suitable way (e.g., with or without a mask) as described above with respect to FIGS. 4A and 4B. In addition, although FIGS. 5A and 5B show each exemplary mask being based directly on its respective scoring vector, the processing system may also be configured to select which tokens to preserve for the next iteration or time-step based indirectly on the scores of the scoring vector (e.g., by first introducing noise into the scoring vector in order to randomize the scores, and then selecting a set of one or more tokens having the most favorable scores in that modified scoring vector).

In the exemplary process flow 500 of FIGS. 5A and 5B, time-step t=0 follows the same procedure as time-step t=0 of the exemplary process flow 400 of FIGS. 4A and 4B, beginning with the same first masked vector 402, and producing the same first output vector 406 with the same first plurality of tokens, and the same first scoring vector 410. Time-step t=0 of the exemplary process flow 500 of FIGS. 5A and 5B also results in the same token of the first output vector 406 being selected for preservation, and thus shows the same illustrative first mask 412.

Similarly, the first iteration n=1 of time-step t=1 also follows the same initial procedure as time-step t=1 of the exemplary process flow 400 of FIGS. 4A and 4B, beginning with the same second masked vector 414, and producing the same second output vector 416 with the same second plurality of tokens, and the same second scoring vector 418. However, in the exemplary process flow 500 of FIGS. 5A and 5B, the processing system is configured to preserve only one token (rather than two, as in time-step t=1 of FIGS. 4A and 4B), as shown in illustrative mask 520. Thus, in this example, once the processing system has identified the element of the second scoring vector 418 with the highest score (in this case, the element in the top right corner with a score of 0.96), it will select the corresponding element of the second output vector 416 for inclusion the third masked vector 522.

In the exemplary process flow 500 of FIGS. 5A and 5B, it is assumed that there will only be two iterations in time-step t=1. As such, in the second iteration n=2 of time-step t=1, the procedure will be the same as the prior iteration, but will culminate in a different number of tokens being preserved. Thus, in the example of FIGS. 5A and 5B, the second iteration n=2 of time-step t=1 begins with a third masked vector 522 in which one token (shown in white, with a value of 21) is preserved from the second output vector 416. As in all other iterations, when the third masked vector 522 is provided to the generative model 404, the generative model 404 will generate predictions as to the masked elements (shown as shaded boxes) based on the unmasked tokens. The resulting third output vector 524 will thus represent a third plurality of tokens that includes the one token preserved from the second output vector 416 and a set of tokens based on the generative model 404's predictions for all masked elements of the third masked vector 522. Here as well, the tokens of the third output vector 524 corresponding to each masked element of the third masked vector 522 may be directly predicted by the generative model 404, or may be indirectly based on the predictions of the generative model 404 (e.g., they may be tokens selected by sampling probability distributions predicted by the generative model 404 for each masked element). The third output vector 524 will then be scored by the token-critic model 408 to generate a third scoring vector 526, which is then used to select a third set of tokens of the third output vector 524 to be preserved for the next time-step. In this case, as iteration n=2 is the final iteration of time-step t=1, the third set of tokens will have a different number of tokens than the second set of tokens preserved from the prior pass. In this example, it is assumed that the processing system is configured to select the two highest-rated tokens (having scores of 0.59 and 0.61), which correspond to the white boxes of the illustrative third mask 528.

Iteration n=1 of time-step t=2 of the exemplary process flow 500 of FIGS. 5A and 5B follows the same procedure as the first iteration of time-step t =1, but begins with a fourth masked vector 530 in which two tokens (shown in white, with values of 21 and 22) are preserved from the third output vector 524. Here as well, when the fourth masked vector 530 is provided to the generative model 404, the generative model 404 will generate predictions as to the masked elements (shown as shaded boxes) based on the unmasked tokens. The resulting fourth output vector 532 will thus represent a fourth plurality of tokens that includes the two tokens preserved from the third output vector 524 and a set of tokens based on the generative model 404's predictions for all masked elements of the fourth masked vector 530. Here as well, the tokens of the fourth output vector 532 corresponding to each masked element of the fourth masked vector 530 may be directly predicted by the generative model 404, or may be indirectly based on the predictions of the generative model 404 (e.g., they may be tokens selected by sampling probability distributions predicted by the generative model 404 for each masked element). The fourth output vector 532 will then be scored by the token-critic model 408 to generate a fourth scoring vector 534, which is then used to select a fourth set of tokens of the fourth output vector 532 to be preserved for the next iteration of the time-step. In this case, as iteration n =1 is not the final iteration of time-step t =1, the fourth set of tokens will have the same number of tokens as the third set of tokens preserved from the prior pass. Thus, this selection will again pick the two highest-rated tokens (having scores of 0.61 and 0.71), which correspond to the white boxes of the illustrative fourth mask 536.

As is it is assumed in the exemplary process flow 500 of FIGS. 5A and 5B that time-step t=2 will have three iterations, the second iteration will follow the same procedure as the prior iteration. Thus, iteration n=2 of time-step t=2 begins with a fifth masked vector 538 in which two tokens (shown in white, with values of 45 and 22) are preserved from the fourth output vector 532. Here as well, when the fifth masked vector 538 is provided to the generative model 404, the generative model 404 will generate predictions as to the masked elements (shown as shaded boxes) based on the unmasked tokens. The resulting fifth output vector 540 will thus represent a fifth plurality of tokens that includes the two tokens preserved from the fourth output vector 532 and a set of tokens based on the generative model 404's predictions for all masked elements of the fifth masked vector 538. Here as well, the tokens of the fifth output vector 540 corresponding to each masked element of the fifth masked vector 538 may be directly predicted by the generative model 404, or may be indirectly based on the predictions of the generative model 404 (e.g., they may be tokens selected by sampling probability distributions predicted by the generative model 404 for each masked element). The fifth output vector 540 will then be scored by the token-critic model 408 to generate a fifth scoring vector 542, which is then used to select a fifth set of tokens of the fifth output vector 540 to be preserved for the next iteration of the time-step. Here again, as this is not the final iteration of time-step t=2, the fifth set of tokens will have the same number of tokens as the fourth set of tokens preserved from the prior pass. Thus, this selection will again pick the two highest-rated tokens (having scores of 0.59 and 0.57), which correspond to the white boxes of the illustrative fifth mask 544.

Finally, as is it is assumed in the exemplary process flow 500 of FIGS. 5A and 5B that time-step t=2 will have three iterations, the third iteration will follow the same procedure as the final iteration of time-step t=1. As such, in the third iteration n=3 of time-step t=2, the procedure will be the same as the prior iteration, but will culminate in a different number of tokens being preserved. Thus, iteration n=3 of time-step t=2 begins with a sixth masked vector 546 in which two tokens (shown in white, with values of 18 and 45) are preserved from the third output vector 524. Here as well, when the sixth masked vector 546 is provided to the generative model 404, the generative model 404 will generate predictions as to the masked elements (shown as shaded boxes) based on the unmasked tokens. The resulting sixth output vector 548 will thus represent a sixth plurality of tokens that includes the two tokens preserved from the fifth output vector 540 and a set of tokens based on the generative model 404's predictions for all masked elements of the sixth masked vector 546. Here as well, the tokens of the sixth output vector 548 corresponding to each masked element of the sixth masked vector 546 may be directly predicted by the generative model 404, or may be indirectly based on the predictions of the generative model 404 (e.g., they may be tokens selected by sampling probability distributions predicted by the generative model 404 for each masked element). The sixth output vector 548 will then be scored by the token-critic model 408 to generate a sixth scoring vector 550, which is then used to select a sixth set of tokens of the sixth output vector 548 to be preserved for the next time-step. In this case, as iteration n=3 is the final iteration of time-step t=2, the sixth set of tokens will have a different number of tokens than the fifth set of tokens preserved from the prior pass. In this example, it is assumed that the processing system is configured to select the four highest-rated tokens (having scores of 0.64, 0.69, 0.54, and 0.53), which correspond to the white boxes of the illustrative sixth mask 552. The first iteration of time-step t=3 will thus begin with a seventh masked vector 554 in which four tokens (shown in white, with values of 18, 45, 17, and 18) are preserved from the sixth output vector 548.

As indicated by the ellipsis following the seventh masked vector 554, the exemplary process flow 500 of FIGS. 5A and 5B may be repeated in the same manner just described for any suitable number of additional time-steps and iterations.

While it has been assumed in FIGS. 5A and 5B that multiple iterations will be made in time-steps t=1, t=2, and t=3, this has been done solely for the purposes of illustrating how a process flow will proceed when there are multiple iterations in a given time-step. It will be understood that any suitable number of iterations may be employed in a given time-step, and that there may be different numbers of iterations used in each time-step (including time-steps in which only a single pass is made). In that regard, in practice, iterating within early time-steps may not be worthwhile, as the generative model 404 will be making predictions for a majority of the tokens in those time-steps, making those predictions relatively random and weak. As such, altering which tokens are unmasked in early time-steps may be less likely to make a meaningful difference in the quality of the generative model's predictions than those made during middle time-steps. Likewise, iterating within later time-steps may also be less worthwhile, as the generative model 404 will be making its predictions based on a relatively small percentage of unmasked tokens in those time-steps, making those predictions less likely to change depending on which tokens are masked. For this reason, in some aspects of the technology, it may be advantageous for the processing system to follow a schedule in which it iterates more during middle time-steps, and less during early and late time-steps. For example, in some aspects, the processing system may use a trapezoidal schedule in which additional iterations begin at some predetermined time-slot, build up in number according to some function (e.g., a linear, parametric, or step function), plateau at a certain level for a fixed number of time-slots, and then taper back to zero by some predetermined time-slot according to another function (e.g., a linear, parametric, or step function).

FIG. 6 sets forth an exemplary method 600 representing a pass through one time-step t into the next time-step t+1 in the exemplary process flows of FIGS. 4A-4B or FIGS. 5A-5B, or a pass within a time-step t from iteration n into iteration n+1 in the exemplary process flow of FIGS. 5A-5B, in accordance with aspects of the disclosure. Exemplary method 600 (and exemplary method 700 of FIG. 7) may be used where the first neural network includes a generative model (e.g., generative model 316 of FIG. 3, generative model 404 of FIGS. 4A-5B) configured to directly predict each masked token, as discussed above with respect to FIGS. 3-5B.

In step 602, the processing system (e.g., processing system 102 of FIGS. 1 and 2) predicts, using the first neural network, a first plurality of tokens representing a first vector-quantized image.

The first neural network may be any suitable neural network configured to receive one or more masked tokens as input and produce predictions regarding the one or more masked tokens. Thus, the first neural network may be a trained non-autoregressive transformer or discrete diffusion model based on a standard transformer architecture, bidirectional encoder transformer architecture, or any other suitable transformer architecture. Likewise, the first neural network may be configured in any of the ways described above with respect to the generative model 316 of FIG. 3 and/or the generative model 404 of FIGS. 4A-5B.

Further, the first plurality of tokens predicted by the first neural network may be represented and formatted in any suitable way, including any of the options described above with respect to the output vectors of FIGS. 3-5B (output vectors 318, 406, 416, 424, 432, 440, 448, 456, 464, 524, 532, 540, 548). Likewise, this first plurality of tokens may represent a first vector-quantized image in any suitable way, including in the same way that the first output vector 406 is described and depicted as representing image 407 in FIGS. 4A, 4C, and 5A above.

In step 604, the processing system generates, using a second neural network, a first plurality of scores based on the first plurality of tokens, each score of the first plurality of scores representing a prediction of whether a token of the first plurality of tokens was generated by a generative model.

The second neural network may be any suitable neural network trained to receive a plurality of tokens and output a score for each given token of the plurality of tokens, where the score represents its prediction of whether the given token was or was not generated by a generative model. Thus, the second neural network may be a trained transformer or bidirectional encoder transformer of any suitable size and number of parameters. Likewise, the second neural network may be trained and configured in any of the ways described above with respect to the token-critic model 320 of FIG. 3 and/or the token-critic model 408 of FIGS. 4A-5B.

Further, the first plurality of scores predicted by the second neural network may be represented and formatted in any suitable way, including any of the options described above with respect to the scoring vectors of FIGS. 3-5B (scoring vectors 322, 410, 418, 426, 434, 442, 450, 458, 526, 534, 542, 550). Likewise, this first plurality of scores may represent the predictions of the second neural network in any suitable way (e.g., any suitable scoring paradigm, range of scoring values, precision of scoring values, etc.), including in the same way that the first scoring vector 410 is described as representing the predictions of the token-critic model 408 in FIGS. 4A and 5A above.

In step 606, the processing system selects a first set of one or more tokens of the first plurality of tokens based on the first plurality of scores.

Here as well, the processing system may use any suitable selection paradigm for selecting the first set of one or more tokens from within the first plurality of tokens. Thus, in some aspects of the technology, the processing system may be configured to select which tokens to preserve for the next time-step based indirectly on the scores in the first plurality of scores. For example, the processing system may select a set of one or more tokens having the most favorable scores (e.g., the highest values), as exemplified in each of the time-steps and iterations of FIGS. 4A-5B. Likewise, in some aspects of the technology, the processing system may select which tokens to preserve for the next time-step based indirectly on the scores within the first plurality of scores. For example, the processing system may first modify the first plurality of scores (e.g., by introducing noise in order to randomize the scores), and then may select a set of one or more tokens having the most favorable scores (e.g., the highest values) in that modified version of the first plurality of scores. Moreover, in some aspects of the technology, the processing system may be further configured to choose whether and how much to modify the first plurality of scores based on how many time-steps or iterations have already been performed. For example, in some aspects, the processing system may be configured to only introduce noise into the first plurality of scores during the first time-step or the first n time-steps, and to make selections based directly on the scores of the second neural network for each time-step thereafter.

In addition, the first set of one or more tokens may be represented, formatted, and generated in any suitable way, including any of the options described above with respect to the masks of FIGS. 4A-5B (masks 412, 420, 428, 436, 444, 452, 460, 520, 528, 536, 544, 552) and/or the masked vectors of FIGS. 4A-5B (masked vectors 414, 422, 430, 438, 446, 454, 462, 522, 530, 538, 546, 554).

In step 608, the processing system predicts, using the first neural network, a second plurality of tokens based on the first set of tokens, the second plurality of tokens including the first set of tokens and representing a second vector-quantized image.

Here as well, the first neural network may predict the second plurality of tokens based on the first set of tokens in any suitable way, including as described above with respect to the generation of the second output vector 416 based on the second masked vector 414 in FIGS. 4A and 5A.

Further, the second plurality of tokens predicted by the first neural network may be represented and formatted in any suitable way, including any of the options described above with respect to the output vectors of FIGS. 3-5B (output vectors 318, 406, 416, 424, 432, 440, 448, 456, 464, 524, 532, 540, 548). Likewise, this second plurality of tokens may represent a second vector-quantized image in any suitable way, including in the same way that the second output vector 416 is described and depicted as representing image 417 in FIGS. 4A, 4C, and 5A above.

FIG. 7 sets forth an exemplary method 700, building from the method of FIG. 6, for a pass through time-step t+1 into the next time-step t+2 in the exemplary process flow of FIGS. 4A-4B or FIGS. 5A-5B, or a pass within a time-step t from iteration n into iteration n+1 in the exemplary process flow of FIGS. 5A-5B, in accordance with aspects of the disclosure. For example, method 600 may represent a pass from time-step t=0 into time-step t=1 of FIG. 4A, and method 700 may represent a pass from time-step t=1 into time-step t=2 of FIG. 4A. Likewise, method 600 may represent a pass from time-step t=0 into iteration n=1 of time-step t=1 of FIG. 5A, and method 700 may represent a pass from iteration n=1 of time-step t=1 into iteration n=2 of time-step t=1 of FIG. 5A.

As shown in step 702, method 700 assumes that the processing system has performed each of the steps of method 600 of FIG. 6, as described above.

Then, in step 704, the processing system generates, using the second neural network, a second plurality of scores based on the second plurality of tokens, each score of the second plurality of scores representing a prediction of whether a token of the second plurality of tokens was generated by a generative model.

Here as well, the second plurality of scores predicted by the second neural network may be represented and formatted in any suitable way, including any of the options described above with respect to the scoring vectors of FIGS. 3-5B (scoring vectors 322, 410, 418, 426, 434, 442, 450, 458, 526, 534, 542, 550). Likewise, this second plurality of scores may represent the predictions of the second neural network in any suitable way (e.g., any suitable scoring paradigm, range of scoring values, precision of scoring values, etc.), including in the same way that the second scoring vector 418 is described as representing the predictions of the token-critic model 408 in FIGS. 4A and 5A above.

In step 706, the processing system selects a second set of one or more tokens of the second plurality of tokens based on the second plurality of scores.

Here as well, the processing system may use any suitable selection paradigm for selecting the second set of one or more tokens from within the second plurality of tokens, including any of the options discussed above with respect to step 606 of FIG. 6.

In addition, the second set of one or more tokens may be represented, formatted, and generated in any suitable way, including any of the options described above with respect to the masks of FIGS. 4A-5B (masks 412, 420, 428, 436, 444, 452, 460, 520, 528, 536, 544, 552) and/or the masked vectors of FIGS. 4A-5B (masked vectors 414, 422, 430, 438, 446, 454, 462, 522, 530, 538, 546, 554).

In step 708, the processing system predicts, using the first neural network, a third plurality of tokens based on the second set of tokens, the third plurality of tokens including the second set of tokens and representing a third vector-quantized image.

Here as well, the first neural network may predict the third plurality of tokens based on the second set of tokens in any suitable way, including as described above with respect to the generation of the third output vector 424 based on the third masked vector 422 in FIG. 4A or the generation of the third output vector 524 based on the third masked vector 522 in FIG. 5A.

Further, the third plurality of tokens predicted by the first neural network may be represented and formatted in any suitable way, including any of the options described above with respect to the output vectors of FIGS. 3-5B (output vectors 318, 406, 416, 424, 432, 440, 448, 456, 464, 524, 532, 540, 548). Likewise, this third plurality of tokens may represent a third vector-quantized image in any suitable way, including in the same way that the third output vector 424 is described and depicted as representing image 425 in FIGS. 4A and 4C above.

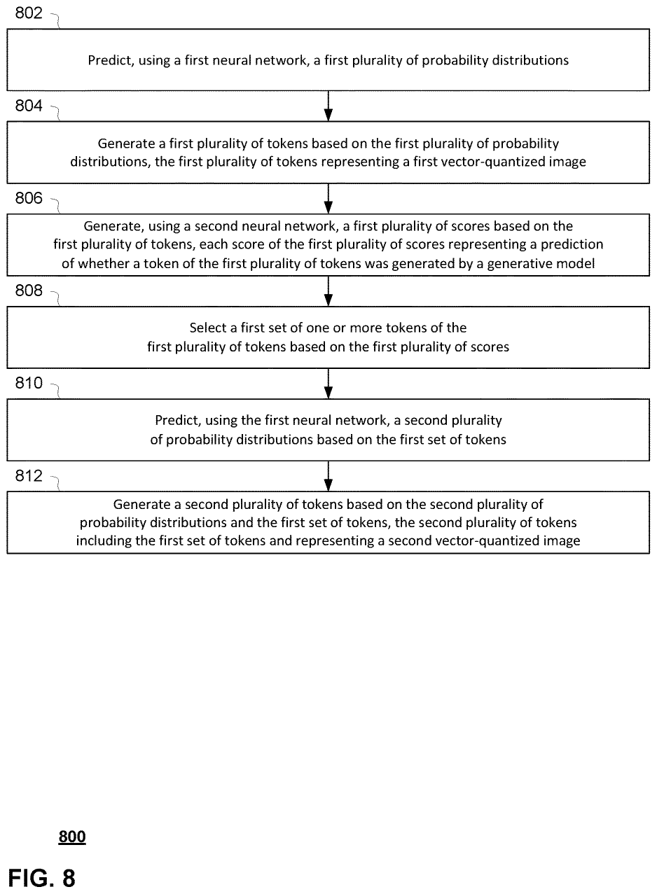

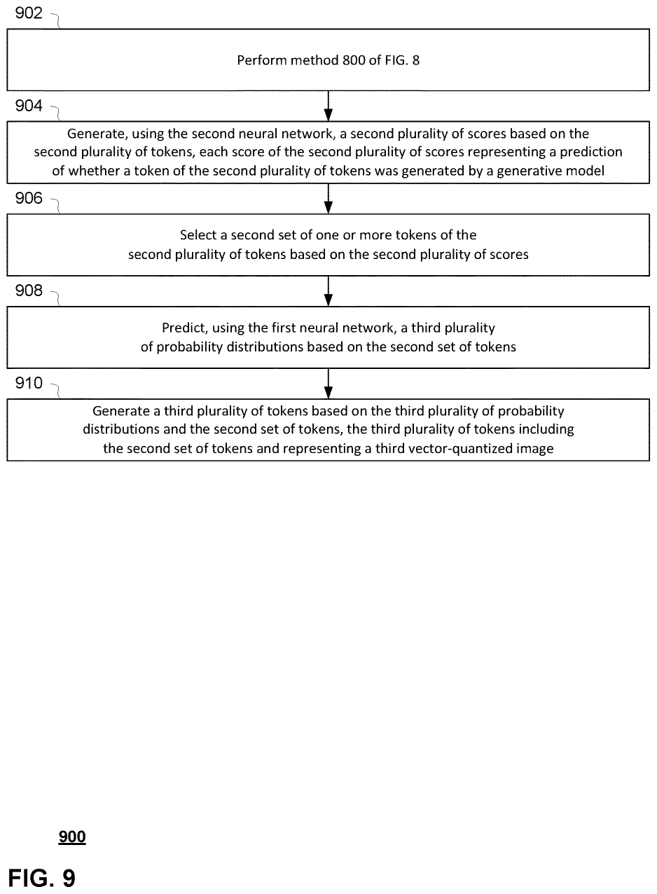

FIG. 8 sets forth an exemplary method 800 representing a pass through one time-step t into the next time-step t+1 in the exemplary process flow of FIGS. 4A-4B, or a pass within time-step t from iteration n into iteration n+1 in the exemplary process flow of FIGS. 5A-5B, in accordance with aspects of the disclosure. Exemplary method 800 (and exemplary method 900 of FIG. 9) may be used where the first neural network includes a generative model (e.g., generative model 316 of FIG. 3, generative model 404 of FIGS. 4A-5B) configured to predict probability distributions for each masked token, as discussed above with respect to FIGS. 3-5B.

In step 802, the processing system (e.g., processing system 102 of FIGS. 1 and 2) predicts, using a first neural network, a first plurality of probability distributions.

Here as well, the first neural network may be any suitable neural network configured to receive one or more masked tokens as input and produce predicted probability distributions for each of the one or more masked tokens. Thus, the first neural network may be a trained non-autoregressive transformer or discrete diffusion model based on a standard transformer architecture, bidirectional encoder transformer architecture, or any other suitable transformer architecture. Likewise, the first neural network may be configured in any of the ways described above with respect to the generative model 316 of FIG. 3 and/or the generative model 404 of FIGS. 4A-5B.

Further, the first plurality of probability distributions predicted by the first neural network may be represented and formatted in any suitable way, including any of the options described above with respect to FIGS. 3-5B. For example, in some aspects of the technology, each probability distribution in the first plurality of probability distributions may represent a prediction for a different portion of an image being synthesized by the first neural network. In such a case, a probability distribution for a given portion of that image may be a sequence or vector representing, for every possible token, a predicted likelihood that the given portion of the image should be represented by that token.

In step 804, the processing system generates a first plurality of tokens based on the first plurality of probability distributions, the first plurality of tokens representing a first vector-quantized image.

The processing system may generate the first plurality of tokens based on the first plurality of probability distributions in any suitable way. For example, as discussed above, the probability distribution for a given portion of an image may be a sequence or vector representing, for every possible token, a predicted likelihood that the given portion of the image should be represented by that token. In such a case, the processing system may be configured to select a token from within each probability distribution using random sampling, with the predicted likelihoods of each possible token being used as sampling weights. Likewise, in some aspects, the processing system may be configured to select a token from within each probability distribution according to which token has the highest predicted likelihood in the probability distribution.

Further, once the processing system selects each token of the first plurality of tokens, the first plurality of tokens may be represented and formatted in any suitable way, including any of the options described above with respect to the output vectors of FIGS. 3-5B (output vectors 318, 406, 416, 424, 432, 440, 448, 456, 464, 524, 532, 540, 548). Likewise, this first plurality of tokens may represent a first vector-quantized image in any suitable way, including in the same way that the first output vector 406 is described and depicted as representing image 407 in FIGS. 4A, 4C, and 5A above.

In step 806, the processing system generates, using a second neural network, a first plurality of scores based on the first plurality of tokens, each score of the first plurality of scores representing a prediction of whether a token of the first plurality of tokens was generated by a generative model.

Here as well, the second neural network may be any suitable neural network trained to receive a plurality of tokens and output a score for each given token of the plurality of tokens, where the score represents its prediction of whether the given token was or was not generated by a generative model. Thus, the second neural network may be a trained transformer or bidirectional encoder transformer of any suitable size and number of parameters. Likewise, the second neural network may be trained and configured in any of the ways described above with respect to the token-critic model 320 of FIG. 3 and/or the token-critic model 408 of FIGS. 4A-5B.

Further, the first plurality of scores predicted by the second neural network may be represented and formatted in any suitable way, including any of the options described above with respect to the scoring vectors of FIGS. 3-5B (scoring vectors 322, 410, 418, 426, 434, 442, 450, 458, 526, 534, 542, 550). Likewise, this first plurality of scores may represent the predictions of the second neural network in any suitable way (e.g., any suitable scoring paradigm, range of scoring values, precision of scoring values, etc.), including in the same way that the first scoring vector 410 is described as representing the predictions of the token-critic model 408 in FIGS. 4A and 5A above.

In step 808, the processing system selects a first set of one or more tokens of the first plurality of tokens based on the first plurality of scores.

Here as well, the processing system may use any suitable selection paradigm for selecting the first set of one or more tokens from within the first plurality of tokens. Thus, in some aspects of the technology, the processing system may be configured to select which tokens to preserve for the next time-step based indirectly on the scores in the first plurality of scores. For example, the processing system may select a set of one or more tokens having the most favorable scores (e.g., the highest values), as exemplified in each of the time-steps and iterations of FIGS. 4A-5B. Likewise, in some aspects of the technology, the processing system may select which tokens to preserve for the next time-step based indirectly on the scores within the first plurality of scores. For example, the processing system may first modify the first plurality of scores (e.g., by introducing noise in order to randomize the scores), and then may select a set of one or more tokens having the most favorable scores (e.g., the highest values) in that modified version of the first plurality of scores. Moreover, in some aspects of the technology, the processing system may be further configured to choose whether and how much to modify the first plurality of scores based on how many time-steps or iterations have already been performed. For example, in some aspects, the processing system may be configured to only introduce noise into the first plurality of scores during the first time-step or the first n time-steps, and to make selections based directly on the scores of the second neural network for each time-step thereafter.

In addition, the first set of one or more tokens may be represented, formatted, and generated in any suitable way, including any of the options described above with respect to the masks of FIGS. 4A-5B (masks 412, 420, 428, 436, 444, 452, 460, 520, 528, 536, 544, 552) and/or the masked vectors of FIGS. 4A-5B (masked vectors 414, 422, 430, 438, 446, 454, 462, 522, 530, 538, 546, 554).

In step 810, the processing system predicts, using the first neural network, a second plurality of probability distributions based on the first set of tokens.

Here as well, the first neural network may predict the second plurality of probability distributions based on the first set of tokens in any suitable way, including as described above with respect to the generation of the second output vector 416 based on the second masked vector 414 in FIGS. 4A and 5A.

Further, the second plurality of probability distributions predicted by the first neural network may be represented and formatted in any suitable way, including any of the options described above with respect to FIGS. 3-5B and/or step 802 of FIG. 8.

In step 812, the processing system generates a second plurality of tokens based on the second plurality of probability distributions and the first set of tokens, the second plurality of tokens including the first set of tokens and representing a second vector-quantized image.

Here as well, the first neural network may generate the second plurality of tokens based on the second plurality of probability distributions and the first set of tokens in any suitable way, including as described above with respect to the generation of the second output vector 416 based on the second masked vector 414 in FIGS. 4A and 5A. For example, the processing system may generate the second plurality of tokens by sampling each probability distribution of the second plurality of probability distributions in any of the ways described above with respect to step 804 of FIG. 8, and then combine those sampled tokens with the first set of tokens.

Further, the second plurality of tokens predicted may be represented and formatted in any suitable way, including any of the options described above with respect to the output vectors of FIGS. 3-5B (output vectors 318, 406, 416, 424, 432, 440, 448, 456, 464, 524, 532, 540, 548). Likewise, this second plurality of tokens may represent a second vector-quantized image in any suitable way, including in the same way that the second output vector 416 is described and depicted as representing image 417 in FIGS. 4A, 4C, and 5A above.

FIG. 9 sets forth an exemplary method 900, building from the method of FIG. 8, for a pass through time-step t+1 into the next time-step t+2 in the exemplary process flow of FIGS. 4A-4B, in accordance with aspects of the disclosure. For example, method 800 may represent a pass from time-step t=0 into time-step t=1 of FIG. 4A, and method 900 may represent a pass from time-step t=1 into time-step t=2 of FIG. 4A. Likewise, method 800 may represent a pass from time-step t=0 into iteration n=1 of time-step t=1 of FIG. 5A, and method 900 may represent a pass from iteration n=1 of time-step t=1 into iteration n=2 of time-step t=1 of FIG. 5A.

As shown in step 902, method 900 assumes that the processing system has performed each of the steps of method 800 of FIG. 8, as described above.

Then, in step 904, the processing system generates, using the second neural network, a second plurality of scores based on the second plurality of tokens, each score of the second plurality of scores representing a prediction of whether a token of the second plurality of tokens was generated by a generative model.

Here as well, the second plurality of scores predicted by the second neural network may be represented and formatted in any suitable way, including any of the options described above with respect to the scoring vectors of FIGS. 3-5B (scoring vectors 322, 410, 418, 426, 434, 442, 450, 458, 526, 534, 542, 550). Likewise, this second plurality of scores may represent the predictions of the second neural network in any suitable way (e.g., any suitable scoring paradigm, range of scoring values, precision of scoring values, etc.), including in the same way that the second scoring vector 418 is described as representing the predictions of the token-critic model 408 in FIGS. 4A and 5A above.

In step 906, the processing system selects a second set of one or more tokens of the second plurality of tokens based on the second plurality of scores.

Here as well, the processing system may use any suitable selection paradigm for selecting the second set of one or more tokens from within the second plurality of tokens, including any of the options discussed above with respect to step 808 of FIG. 8.

In addition, the second set of one or more tokens may be represented, formatted, and generated in any suitable way, including any of the options described above with respect to the masks of FIGS. 4A-5B (masks 412, 420, 428, 436, 444, 452, 460, 520, 528, 536, 544, 552) and/or the masked vectors of FIGS. 4A-5B (masked vectors 414, 422, 430, 438, 446, 454, 462, 522, 530, 538, 546, 554).

In step 908, the processing system predicts, using the first neural network, a third plurality of probability distributions based on the second set of tokens.

Here as well, the first neural network may predict the third plurality of probability distributions based on the second set of tokens in any suitable way, including as described above with respect to the generation of the third output vector 424 based on the third masked vector 422 in FIG. 4A or the generation of the third output vector 524 based on the third masked vector 522 in FIG. 5A.

Further, the third plurality of probability distributions predicted by the first neural network may be represented and formatted in any suitable way, including any of the options described above with respect to FIGS. 3-5B and/or step 802 of FIG. 8.

In step 910, the processing system generates a third plurality of tokens based on the third plurality of probability distributions and the second set of tokens, the third plurality of tokens including the second set of tokens and representing a third vector-quantized image.

Here as well, the first neural network may generate the third plurality of tokens based on the third plurality of probability distributions and the second set of tokens in any suitable way, including as described above with respect to the generation of the third output vector 424 based on the third masked vector 422 in FIG. 4A. For example, the processing system may generate the third plurality of tokens by sampling each probability distribution of the third plurality of probability distributions in any of the ways described above with respect to step 804 of FIG. 8, and then combine those sampled tokens with the second set of tokens.

Further, the third plurality of tokens predicted by the first neural network may be represented and formatted in any suitable way, including any of the options described above with respect to the output vectors of FIGS. 3-5B (output vectors 318, 406, 416, 424, 432, 440, 448, 456, 464, 524, 532, 540, 548). Likewise, this third plurality of tokens may represent a third vector-quantized image in any suitable way, including in the same way that the third output vector 424 is described and depicted as representing image 425 in FIGS. 4A and 4C above.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of exemplary systems and methods should be taken by way of illustration rather than by way of limitation of the subject matter defined by the claims. In addition, the provision of the examples described herein, as well as clauses phrased as “such as,” “including,” “comprising,” and the like, should not be interpreted as limiting the subject matter of the claims to the specific examples; rather, the examples are intended to illustrate only some of the many possible embodiments. Further, the same reference numbers in different drawings can identify the same or similar elements.

1. A computer-implemented method of generating an image, comprising:
predicting, using a first neural network, a first plurality of probability distributions;
generating, using one or more processors of a processing system, a first plurality of tokens based on the first plurality of probability distributions, the first plurality of tokens representing a first vector-quantized image;
generating, using a second neural network different than the first neural network, a first plurality of scores based on the first plurality of tokens, each score of the first plurality of scores representing a prediction of whether a token of the first plurality of tokens was generated by a generative model;
selecting, using the one or more processors, a first set of one or more tokens of the first plurality of tokens based on the first plurality of scores;
predicting, using the first neural network, a second plurality of probability distributions based on the first set of tokens; and
generating, using the one or more processors, a second plurality of tokens based on the second plurality of probability distributions and the first set of tokens, the second plurality of tokens including the first set of tokens and representing a second vector-quantized image.

2. The method of claim 1, further comprising:
generating, using the second neural network, a second plurality of scores based on the second plurality of tokens, each score of the second plurality of scores representing a prediction of whether a token of the second plurality of tokens was generated by a generative model;
selecting, using the one or more processors, a second set of one or more tokens of the second plurality of tokens based on the second plurality of scores;
predicting, using the first neural network, a third plurality of probability distributions based on the second set of tokens; and
generating, using the one or more processors, a third plurality of tokens based on the third plurality of probability distributions and the second set of tokens, the third plurality of tokens including the second set of tokens and representing a third vector-quantized image.

3. The method of claim 2, wherein each token of the third plurality of tokens represents a single pixel of the third vector-quantized image.

4. The method of claim 1, wherein:
each token of the second plurality of tokens represents a single pixel of the second vector-quantized image, and
each token of the first plurality of tokens represents a single pixel of the first vector-quantized image.

5-6. (canceled)

7. The method of claim 1, further comprising generating the second vector-quantized image based on the second plurality of tokens.

8. The method of claim 2, further comprising generating the third vector-quantized image based on the third plurality of tokens.

9-10. (canceled)

11. A computer-implemented method of generating an image, comprising:
predicting, using a first neural network, a first plurality of tokens representing a first vector-quantized image;
generating, using a second neural network different than the first neural network, a first plurality of scores based on the first plurality of tokens, each score of the first plurality of scores representing a prediction of whether a token of the first plurality of tokens was generated by a generative model;
selecting, using one or more processors of a processing system, a first set of one or more tokens of the first plurality of tokens based on the first plurality of scores; and
predicting, using the first neural network, a second plurality of tokens based on the first set of tokens, the second plurality of tokens including the first set of tokens and representing a second vector-quantized image.

12. The method of claim 11, further comprising:
generating, using the second neural network, a second plurality of scores based on the second plurality of tokens, each score of the second plurality of scores representing a prediction of whether a token of the second plurality of tokens was generated by a generative model;
selecting, using the one or more processors, a second set of one or more tokens of the second plurality of tokens based on the second plurality of scores; and
predicting, using the first neural network, a third plurality of tokens based on the second set of tokens, the third plurality of tokens including the second set of tokens and representing a third vector-quantized image.

13. (canceled)

14. The method of claim 11, wherein:
each token of the second plurality of tokens represents a single pixel of the second vector-quantized image, and
each token of the first plurality of tokens represents a single pixel of the first vector-quantized image.

15. (canceled)

16. The method of claim 11, wherein:
each token of the second plurality of tokens represents two or more pixels of the second vector-quantized image, and
each token of the first plurality of tokens represents two or more pixels of the first vector-quantized image.

17. The method of claim 11, further comprising generating the second vector-quantized image based on the second plurality of tokens.

18-20. (canceled)

21. A processing system comprising:
a memory storing a first neural network and a second neural network, the first neural network being different than the second neural network; and
one or more processors coupled to the memory and configured to:
predict, using the first neural network, a first plurality of probability distributions;
generate a first plurality of tokens based on the first plurality of probability distributions, the first plurality of tokens representing a first vector-quantized image;
generate, using the second neural network, a first plurality of scores based on the first plurality of tokens, each score of the first plurality of scores representing a prediction of whether a token of the first plurality of tokens was generated by a generative model;
select a first set of one or more tokens of the first plurality of tokens based on the first plurality of scores;
predict, using the first neural network, a second plurality of probability distributions based on the first set of tokens; and
generate a second plurality of tokens based on the second plurality of probability distributions and the first set of tokens, the second plurality of tokens including the first set of tokens and representing a second vector-quantized image.

22. The system of claim 21, wherein the one or more processors are further configured to:
generate, using the second neural network, a second plurality of scores based on the second plurality of tokens, each score of the second plurality of scores representing a prediction of whether a token of the second plurality of tokens was generated by a generative model;
select a second set of one or more tokens of the second plurality of tokens based on the second plurality of scores;
predict, using the first neural network, a third plurality of probability distributions based on the second set of tokens; and
generate a third plurality of tokens based on the third plurality of probability distributions and the second set of tokens, the third plurality of tokens including the second set of tokens and representing a third vector-quantized image.

23. The system of claim 21, wherein the one or more processors are further configured to generate the second vector-quantized image based on the second plurality of tokens.

24. The system of claim 23, wherein the one or more processors are further configured to generate the second vector-quantized image using a decoder of a vector-quantized autoencoder, a decoder of a generative adversarial network, or a decoder of a transformer stored in the memory.

25. The system of claim 22, wherein the one or more processors are further configured to generate the third vector-quantized image based on the third plurality of tokens.

26. (canceled)

27. The system of claim 21, wherein at least one of the first neural network or the second neural network is a transformer.

28. (canceled)

29. A processing system comprising:
a memory storing a first neural network and a second neural network, the first neural network being different than the second neural network; and
one or more processors coupled to the memory and configured to:
predict, using the first neural network, a first plurality of tokens representing a first vector-quantized image;
generate, using the second neural network, a first plurality of scores based on the first plurality of tokens, each score of the first plurality of scores representing a prediction of whether a token of the first plurality of tokens was generated by a generative model;
select a first set of one or more tokens of the first plurality of tokens based on the first plurality of scores; and
predict, using the first neural network, a second plurality of tokens based on the first set of tokens, the second plurality of tokens including the first set of tokens and representing a second vector-quantized image.

30. The system of claim 29, wherein the one or more processors are further configured to:
generate, using the second neural network, a second plurality of scores based on the second plurality of tokens, each score of the second plurality of scores representing a prediction of whether a token of the second plurality of tokens was generated by a generative model;
select a second set of one or more tokens of the second plurality of tokens based on the second plurality of scores; and
predict, using the first neural network, a third plurality of tokens based on the second set of tokens, the third plurality of tokens including the second set of tokens and representing a third vector-quantized image.

31. The system of claim 29, wherein the one or more processors are further configured to generate the second vector-quantized image based on the second plurality of tokens.

32. The system of claim 31, wherein the one or more processors are further configured to generate the second vector-quantized image using a decoder of a vector-quantized autoencoder, a decoder of a generative adversarial network, or a decoder of a transformer stored in the memory.

33-34. (canceled)

35. The system of claim 29, to wherein at least one of the first neural network or the second neural network is a transformer.

36-38. (canceled)
